(19) United States
(12) Patent Application Publication
(10) Pub. No.: US 2025/0036341 A1
(43) Pub. Date: Jan. 30, 2025

(54) WEARABLE ELECTRONIC DEVICE FOR DISPLAYING VIRTUAL OBJECT AND METHOD FOR CONTROLLING THE SAME

(71) Applicant: Samsung Electronics Co., Ltd., Suwon-si (KR)

(72) Inventors: Choonkyoung MOON, Suwon-si (KR); Doosuk KANG, Suwon-si (KR); Hyunkee MIN, Suwon-si (KR); Mingyu LEE, Suwon-si (KR); Bokun CHOI, Suwon-si (KR)

(21) Appl. No.: 18/786,219

(22) Filed: Jul. 26, 2024

Related U.S. Application Data
(63) Continuation of application No. PCT/KR2024/010637, filed on Jul. 23, 2024.

(30) Foreign Application Priority Data
Jul. 26, 2023 (KR) 10-2023-0097398
Nov. 27, 2023 (KR) 10-2023-0167225

(51) Int. Cl. G06F 3/14; G06F 3/01

(52) U.S. Cl. CPC G06F 3/1423; G06F 3/013

(57) ABSTRACT

A wearable electronic device may include a camera, a display, and at least one processor operatively connected, directly or indirectly, to the camera, and the display, wherein the at least one processor may be configured to identify a displayable area corresponding to an external display included in an image of a space acquired through the camera, identify, based on at least a portion of the external display being excluded from the displayable area due to movement of the external display, a first area of the displayable area, in which a portion of the external display is disposed and a second area of the displayable area, which corresponds to a remaining area excluding the first area, and control the display to display a virtual screen on the second area.

### CROSS-REFERENCE TO RELATED APPLICATIONS

This application is a continuation application of International Application No. PCT/KR2024/010637 designating the United States, filed on Jul. 23, 2024, in the Korean Intellectual Property Receiving Office and claiming priority to Korean Patent Application No. 10-2023-0097398 filed on Jul. 26, 2023, and Korean Patent Application No. 10-2023-0167225 filed on Nov. 27, 2023, in the Korean Intellectual Property Office, the entire disclosures of which are all hereby incorporated herein by reference for all purposes.

### TECHNICAL FIELD

Certain example embodiments relate to a wearable electronic device for displaying a virtual object and/or a method for controlling same.

### BACKGROUND ART

Various services and additional functions provided through an electronic device, for example, a mobile electronic device such as a smartphone have been increased. Communication service providers or electronic device manufacturers competitively develop electronic devices for providing various functions and differentiated from other businesses to improve effective values of such electronic devices and satisfy various desires of users. Therefore, various functions provided through electronic devices have been increasingly developed.

Various services and additional functions provided through a wearable electronic device, such as augmented reality glasses, virtual reality glasses, and a head mounted display (HMD) device have been gradually increased. Communication service providers or electronic device manufacturers competitively develop an electronic device for providing various functions and differentiation from other businesses to improve effective values of such electronic device and satisfy various desires of users. Therefore, various functions provided through wearable electronic devices have been increasingly advanced.

The AR glasses or the VR glasses may provide a user with a realistic experience by displaying a virtual image while worn on the user's head. The AR glasses or the VR glasses may replace the usability of smartphones in various fields, such as a game entertainment, an education, or a social networking service (SNS). The user may be provided with a content of a smartphone or a content similar to reality through the AR glasses or the VR glasses mounted on the user's head.

### SUMMARY

According to an example embodiment, a wearable electronic device may include memory, a camera, a display, and at least one processor operatively connected, directly or indirectly, to the memory, the camera, and the display.

According to an example embodiment, the memory may store instructions which cause, when executed by the processor(s), the wearable electronic device to identify a displayable area corresponding to an external display included in an image of a space acquired through the camera of the wearable electronic device.

According to an example embodiment, the memory may store instructions which cause, when executed by the processor(s), the wearable electronic device to identify, based on at least a portion of the external display being excluded from the displayable area due to movement of the external display, a first area of the displayable area, in which a portion of the external display is disposed and a second area of the displayable area, which corresponds to a remaining area excluding the first area.

According to an example embodiment, the memory may store instructions which cause, when executed by the processor(s), the wearable electronic device to control the display to display a virtual screen on the second area.

According to an example embodiment, a method for controlling a wearable electronic device may include an operation of identifying a displayable area corresponding to an external display included in an image of a space acquired through the camera.

According to an example embodiment, the method for controlling a wearable electronic device may include an operation of identifying, based on at least a portion of the external display being excluded from the displayable area due to movement of the external display, a first area of the displayable area, in which a portion of the external display is disposed and a second area of the displayable area, which corresponds to a remaining area excluding the first area.

According to an example embodiment, the method for controlling a wearable electronic device may include an operation of displaying a virtual screen on the second area.

According to an example embodiment, a non-transitory computer readable recording medium storing at least one program may be provided, wherein the at least one program stores instructions which cause a wearable electronic device to identify a displayable area corresponding to an external display included in an image of a space acquired through the camera of the wearable electronic device.

According to an example embodiment, the at least one program may store instructions which cause the wearable electronic device to identify, based on at least a portion of the external display being excluded from the displayable area due to movement of the external display, a first area of the displayable area, in which a portion of the external display is disposed and a second area of the displayable area, which corresponds to a remaining area excluding the first area.

According to an example embodiment, the at least one program may store instructions which cause the wearable electronic device to control the display to display a virtual screen on the second area.

### BRIEF DESCRIPTION OF DRAWINGS

FIG. 1 is a block diagram illustrating an electronic device in a network environment according to an example embodiment.

FIG. 2 is a perspective diagram illustrating an inner configuration of a wearable electronic device according to an example embodiment.

FIG. 3 is a diagram illustrating a front surface of a wearable electronic device according to an example embodiment.

FIG. 4 is a diagram illustrating a rear surface of a wearable electronic device according to an example embodiment.

FIG. 5 is a perspective diagram illustrating a wearable electronic device according to an example embodiment.

FIG. 6 is a diagram schematically illustrating an operation of an electronic device for displaying a virtual screen according to an example embodiment.

FIG. 7A is a diagram illustrating an operation of an electronic device for identifying a displayable area based on an external display according to an example embodiment.

FIG. 7B is a diagram illustrating an embodiment in which a first content is displayed on a displayable area according to an example embodiment.

FIG. 8A is a diagram illustrating an operation of an electronic device for identifying a displayable area as a first area and a second area based on movement of an external display according to an example embodiment.

FIG. 8B is a diagram illustrating an operation of an electronic device for displaying a virtual screen on at least a portion of a displayable area according to an example embodiment.

FIG. 8C is a diagram illustrating an operation of an electronic device for displaying a virtual screen on at least a portion of a displayable area based on user eye tracking according to an example embodiment.

FIG. 9A is a diagram illustrating an operation of an electronic device for displaying a first content on an entire displayable area according to an example embodiment.

FIG. 9B is a diagram illustrating an operation in which a content is displayed on a partial area of a displayable area based on movement of an external display according to an example embodiment.

FIG. 9C is a diagram illustrating an operation of an electronic device for displaying a virtual screen on at least a portion of a displayable area based on movement of an external display according to an example embodiment.

FIG. 9D is a diagram illustrating an operation of an electronic device for displaying a virtual screen on at least a portion of a displayable area based on movement of an external display according to an example embodiment.

FIG. 10 is a diagram illustrating an operation of an electronic device for displaying a virtual screen on at least a portion of a displayable area based on movement of an external display according to an example embodiment.

FIG. 11A is a diagram illustrating an operation of an electronic device for displaying a first content on an entire displayable area according to an example embodiment.

FIG. 11B is a diagram illustrating an operation of an electronic device for displaying a virtual screen on at least a portion of a displayable area based on movement of an external display according to an example embodiment.

FIG. 11C is a diagram illustrating an operation of an electronic device for displaying a virtual screen on at least a portion of a displayable area based on movement of an external display according to an example embodiment.

FIG. 12 is a diagram illustrating an operation of an electronic device for displaying a virtual screen on at least a portion of a displayable area based on movement of an external display according to an example embodiment.

FIG. 13 is a diagram illustrating an operation of an electronic device for displaying a virtual screen on at least a portion of a displayable area based on movement of an external display according to an example embodiment.

FIG. 14 is a flowchart illustrating an operation of an electronic device for acquiring information about movement of an external display according to an example embodiment.

FIG. 15 is a flowchart illustrating an operation of an electronic device for displaying a virtual screen, based on movement of an external display according to an example embodiment.

FIG. 16 is a diagram illustrating an operation of an electronic device for displaying a virtual screen on at least a portion of a displayable area based on movement of an external display according to an example embodiment.

FIG. 17 is a diagram illustrating an operation of an electronic device for displaying a virtual screen on at least a portion of a displayable area, based on movement of a sunroof in case that an external display corresponds to the sunroof according to an example embodiment.

FIG. 18 is a diagram illustrating an operation of an electronic device for displaying a virtual screen on at least a portion of a displayable area, based on movement of a door in case that an external display corresponds to the door according to an example embodiment.

FIG. 19 is a diagram illustrating an operation of an electronic device for displaying a virtual screen on at least a portion of a displayable area, based on rolling of a rollable display in case that an external display corresponds to the rollable display according to an example embodiment.

### DETAILED DESCRIPTION

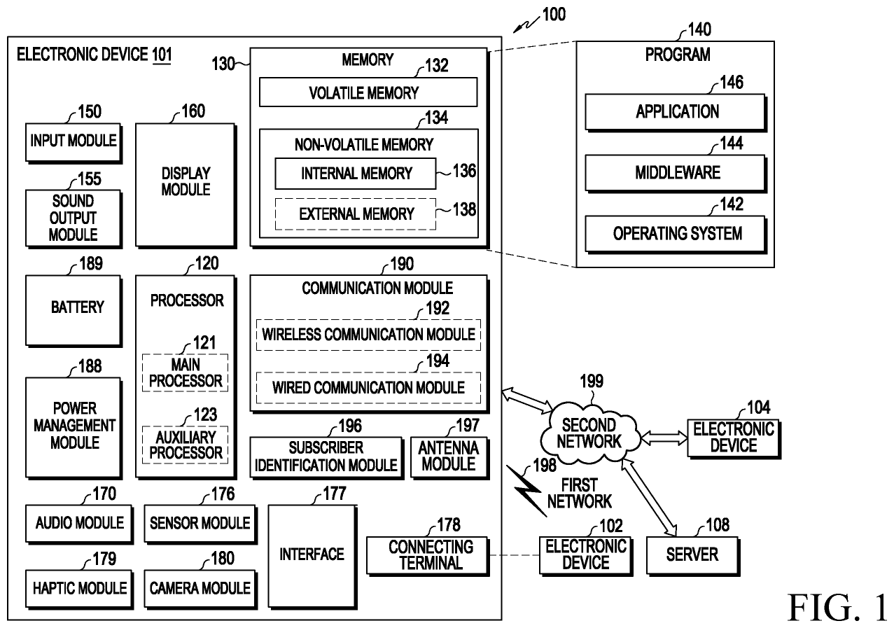

FIG. 1 is a block diagram illustrating an electronic device 101 in a network environment 100 according to embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

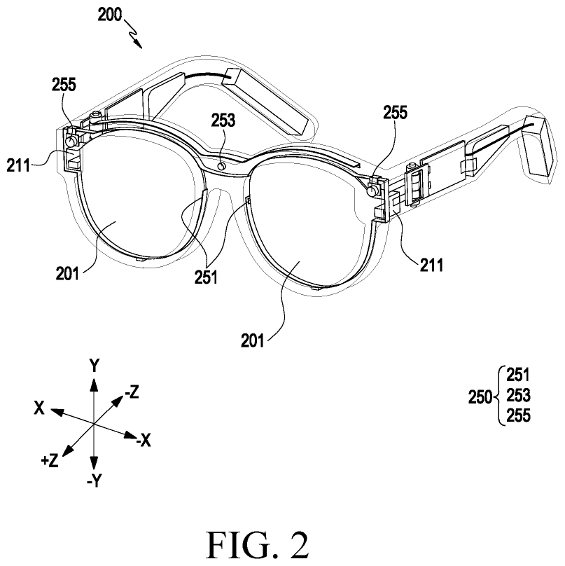

FIG. 2 is a perspective diagram illustrating an inner configuration of a wearable electronic device according to an embodiment.

Referring to FIG. 2, the wearable electronic device 200 according to an embodiment may include at least one of a light output module 211, a display member 201, and a camera module 250.

According to an embodiment, the light output module 211 may include a light source capable of outputting an image and a lens for guiding the image to the display member 201. According to an embodiment, the light output module 211 may include at least one of a liquid crystal display (LCD), a digital mirror device (DMD), a liquid crystal on silicon (LCoS), an organic light-emitting diode (OLED), or a micro light emitting diode (micro-LED).

According to an embodiment, the display member 201 may include an optical waveguide (e.g., a waveguide). According to an embodiment, an output image of the light output module 211 incident on one end of the optical waveguide may be propagated within the optical waveguide and provided to a user. According to an embodiment, the optical waveguide may include at least one of a diffraction element (e.g., a diffractive element (DOE) and a holographic optical element (HOE)) or an reflection element (e.g., a reflective mirror). For example, the optical waveguide may guide an output image of the light output module 211 to the user's eye by using at least one of a diffraction element or a reflection element.

According to an embodiment, the camera module 250 may capture a still image and/or video. According to an embodiment, the camera module 250 may be disposed within a lens frame and around the display member 201.

According to an embodiment, a first camera module 251 may capture and/or recognize the user's eye (e.g., a pupil or an iris) or a trajectory of a gaze. According to an embodiment, the first camera module 251 may periodically or aperiodically transmit information (e.g., trajectory information) on tracking of the user's eye or the trajectory of a gaze to the processor (e.g., the processor 120 in FIG. 1).

Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, a second camera module 253 may capture an image of the outside.

According to an embodiment, a third camera module 255 may be used for hand detection and tracking and recognition of a user gesture (e.g., a hand gesture). The third camera module 255 according to an embodiment may be used for head tracking of 3 degrees of freedom (3DoF) and 6DoF, and location (space, environment) recognition and/or movement recognition. The second camera module 253 may be used for hand detection and tracking and user gesture recognition according to an embodiment. According to an embodiment, at least one of the first camera module 251 to the third camera module 255 may be replaced with a sensor module (e.g., a LiDAR sensor). For example, the sensor module may include at least one of a vertical cavity surface emitting laser, an infrared sensor, and/or a photodiode.

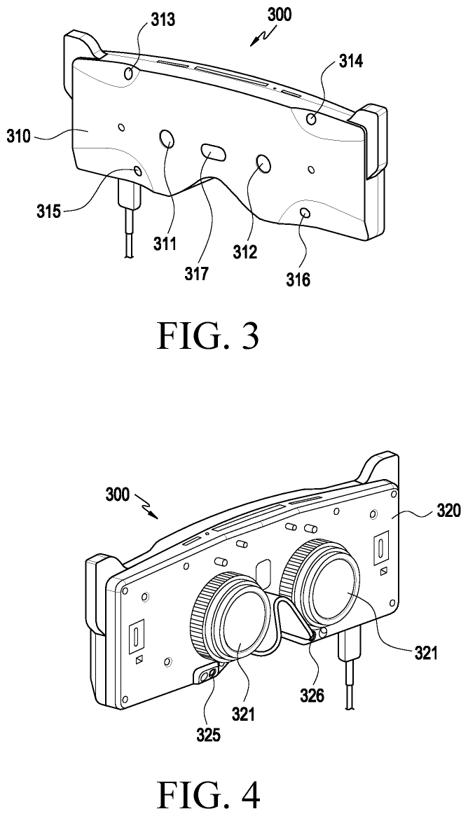

FIG. 3 is a diagram illustrating a front surface of a wearable electronic device according to an embodiment.

FIG. 4 is a diagram illustrating a rear surface of a wearable electronic device according to an embodiment.

Referring to FIGS. 3 and 4, in an embodiment, a depth sensor 317 and/or camera modules 311, 312, 313, 314, 315, and 316 for acquiring information related to a peripheral environment of the wearable electronic device 300 may be arranged on a first surface 310 of a housing.

In an embodiment, the camera modules 311 and 312 may acquire an image related to a peripheral environment of the wearable electronic device.

In an embodiment, the camera modules 313, 314, 315, and 316 may acquire an image in a state in which the wearable electronic device is worn by the user. The camera modules 313, 314, 315, and 316 may be used for hand detection and tracking and recognition of a user gesture (e.g., a hand gesture). The camera modules 313, 314, 315, and 316 may be used for head tracking of 3DoF and 6DoF, location (space, environment) recognition, and/or movement recognition. In an embodiment, the camera modules 311 and 312 may be used for hand detection and tracking and user gesture recognition.

In an embodiment, the depth sensor 317 may be configured to transmit a signal and receive a signal reflected from a subject and may be used to identify a distance to an object, such as time of flight (TOF). Additionally, or in place of the depth sensor 217, the camera modules 313, 314, 315, and 316 may identify a distance to an object.

According to an embodiment, a face recognition camera module 325 or 326 and/or a display 321 (and/or a lens) may be arranged on a second surface 320 of the housing.

In an embodiment, the face recognition camera module 325 or 326 adjacent to the display may be used to recognize a user face or may recognize and/or track both eyes of the user.

In an embodiment, the display 321 (and/or the lens) may be disposed on the second surface 320 of the wearable electronic device 300. In an embodiment, the wearable electronic device 300 may not include the camera modules 315 and 316 among multiple camera modules 313, 314, 315, and 316. Although not shown in FIGS. 3 and 4, the wearable electronic device 300 may further include at least one of components shown in FIG. 2.

As described above, the wearable electronic device 300 according to an embodiment may have a form factor to be mounted on the user's head. The wearable electronic device 300 may further include a strap and/or wearing member for securing same onto a user's body part. The wearable electronic device 300 may provide a user experience based on augmented reality, virtual reality, and/or mixed reality in a state of being mounted on the user head.

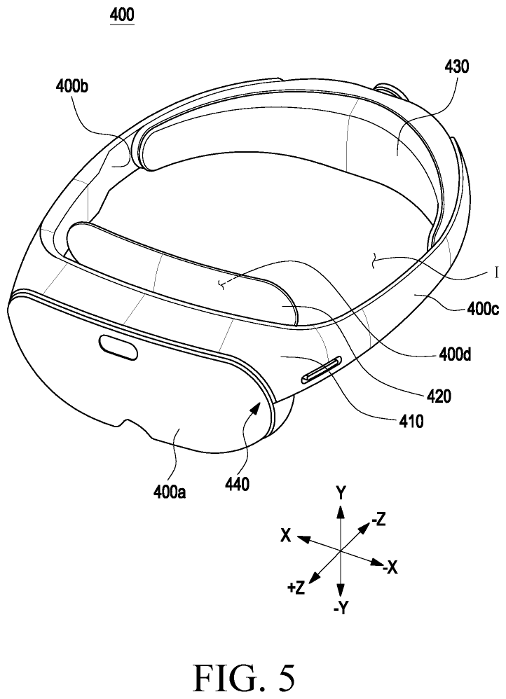

FIG. 5 is a perspective diagram illustrating an electronic device according to an embodiment.

Referring to FIG. 5, the electronic device 400 may include a head mounting device (HMD) which may provide an image in front of the user's eye. The configuration of the electronic device 400 of FIG. 5 may be entirely or partially identical to that of the electronic device 200 of FIG. 2.

According to an embodiment, the electronic device 400 may include a housing 410, 420, or 430 which may configure an exterior of the electronic device 400 and provide a space for receiving components of the electronic device 400 arranged therein.

According to an embodiment, the electronic device 400 may include a first housing 410 which may surround at least a portion of the user head. According to an embodiment, the first housing 410 may include a first surface 400a facing the outside (e.g., the +Z direction) of the electronic device 400.

According to an embodiment, the first housing 410 may surround at least a portion of an internal space I. For example, the first housing 410 may include a second surface 400B facing the internal space I of the electronic device 400 and a third surface 400c opposite to the second surface 400b. According to an embodiment, the first housing 410 may be coupled to the third housing 430 to have a closed curve shape surrounding the internal space I.

According to an embodiment, the first housing 410 may receive at least a portion of components of the electronic device 400. For example, the light output module, and a circuit board may be arranged in the first housing 410.

According to an embodiment, the electronic device 400 may include one display member 440 corresponding to the left eye and the right eye. The display member 440 may be disposed in the first housing 410. The configuration of the display member 440 of FIG. 5 may be entirely or partially identical to that of the display member 201 of FIG. 2.

According to an embodiment, the electronic device 400 may include a second housing 420 which may be placed on the user's face. According to an embodiment, the second housing 420 may include a fourth surface 400d at least partially facing the user's face. According to an embodiment, the fourth surface 400d may correspond to a surface in a direction (e.g., the −Z direction) facing the internal space I of the electronic device 400. According to an embodiment, the second housing 420 may be coupled, directly or indirectly, to the first housing 410.

According to an embodiment, the electronic device 400 may include a third housing 430 which may be placed on the back of the user's head. According to an embodiment, the third housing 430 may be coupled, directly or indirectly, to the first housing 410. According to an embodiment, the third housing 430 may receive at least a portion of components of the electronic device 400. For example, a battery (e.g., the battery 189 in FIG. 1) may be disposed in the third housing 430.

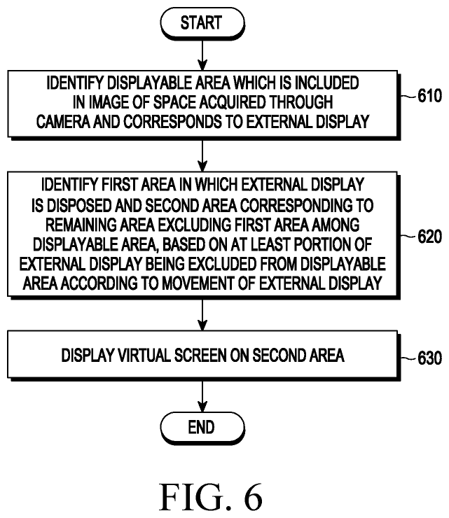

FIG. 6 is a diagram schematically illustrating an operation of an electronic device for displaying a virtual screen according to an embodiment.

Referring to FIG. 6, in operation 610, the electronic device (or a wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a displayable area corresponding to an external display included in an image of a space acquired through the camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3).

According to an embodiment, the electronic device may display an image acquired by capturing an actual space in which the electronic device is located on a display (e.g., the display module 160 in FIG. 1, the display member 201 in FIG. 2, the display 321 in FIG. 4, or the display member 440 in FIG. 5) in real time. For example, the actual space in which the electronic device is located may include an interior of a vehicle, an interior of a building, such as a housing or an office.

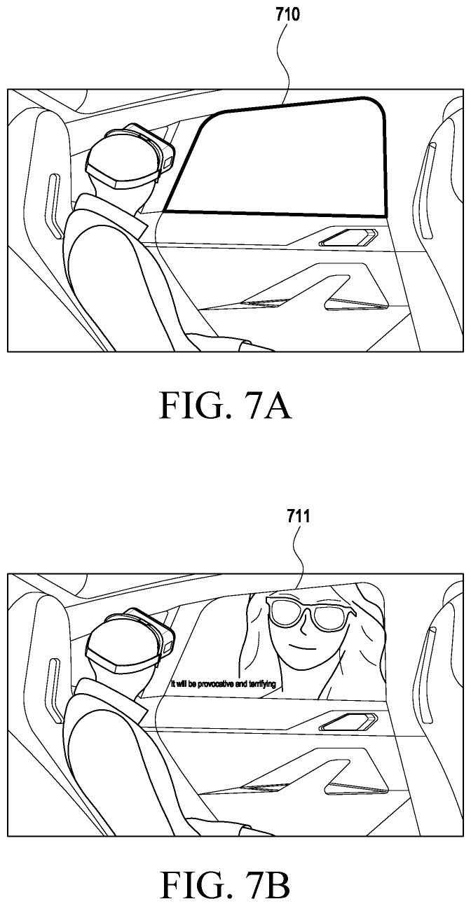

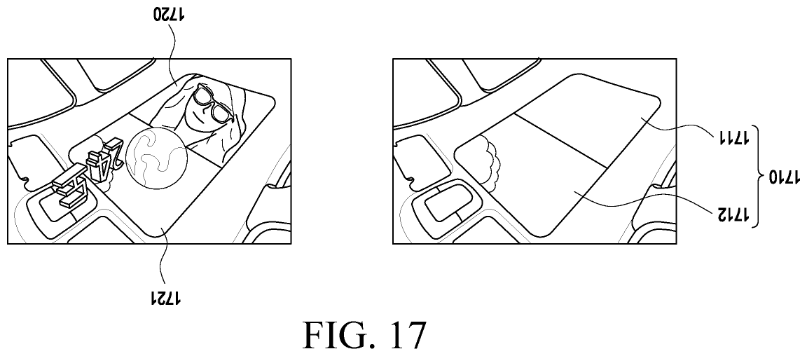

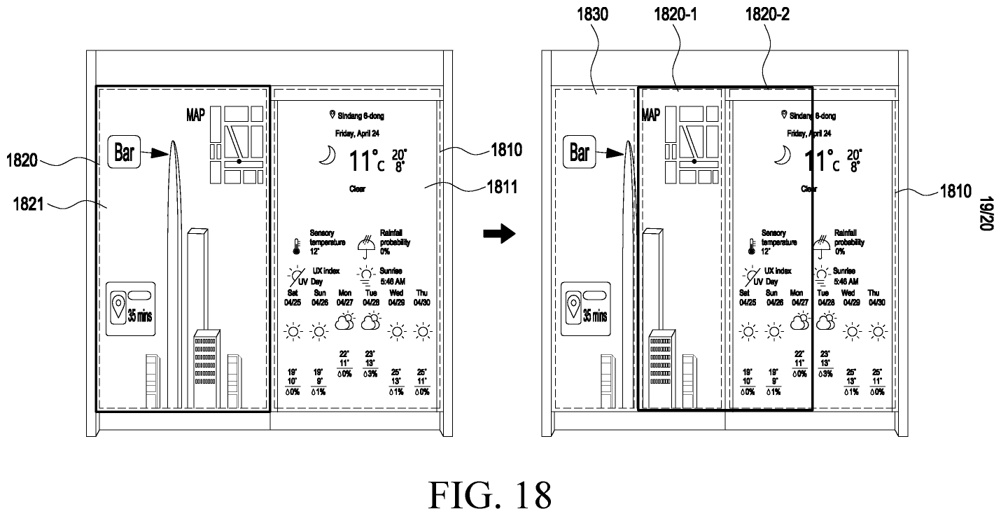

According to an embodiment, the external display may be movable by way of a wall or a housing. At least a partial area of the external display may be divided by a wall or housing according to movement thereof. For example, the external display may include at least one of a window of a vehicle, a sunroof, a window or a door (a glass door or and automatic door) of a building, such as a house or an office. According to an embodiment, an embodiment in which the external display corresponds to a window of a vehicle will be described with reference to FIGS. 7A to 16 below. According to an embodiment, an embodiment in which the external display corresponds to a sunroof will be described with reference to FIG. 17 below. According to an embodiment, an embodiment in which the external display corresponds to a window or a door of a building, such as a house or an office will be described with reference to FIG. 18 below. According to an embodiment, FIGS. 7A to 16 illustrate that the external display corresponds to a window of a vehicle, but the disclosure is not limited thereto, and may be applied to a case in which the external display corresponds to a sunroof of a vehicle, or a window or door in a building as well.

According to an embodiment, the electronic device may perform communication with a control device for controlling the external display. For example, the electronic device may perform communication with an external device configured to control the external display through a near-field communication method, such as BT, BLE, UWB, and Wi-Fi. For example, the external electronic device for controlling the external display may include a control device of a vehicle for controlling a window or a sunroof of the vehicle.

According to an embodiment, the external electronic device may correspond to a terminal device, such as a smartphone which may communicate with a control device of a vehicle. According to an embodiment, the control device of a vehicle may be controlled to control a window or sunroof.

According to an embodiment, the electronic device may identify that the electronic device is located in the vehicle based on communication with the control device, that is the external electronic device, of the vehicle, through a communication module (e.g., the communication module 190 in FIG. 1).

According to an embodiment, the electronic device may receive space data (e.g., 3D data) from the external electronic device. For example, the electronic device may receive vehicle data (e.g., 3D data) from the control device of the vehicle. For example, the vehicle data may be related to a structure inside the vehicle, such as a seating position, a seat type, a window location and/or window shape.

According to an embodiment, the electronic device may identify a displayable area based on the received 3D data. The displayable area may correspond to a maximum area in which a content may be displayed by the external display. For example, in case that the external display corresponds to a window of the vehicle, the displayable area may correspond to an area in which the window is disposed with the window closed.

According to an embodiment, the electronic device may identify a displayable area based on the image acquired through the camera. For example, the electronic device may recognize the image acquired through the camera, recognize the external display (e.g., a window) included in the image, and identify an area corresponding to the external display as the displayable area.

According to an embodiment, the electronic device may recognize the image acquired through the camera and identify that the electronic device is located inside the vehicle.

According to an embodiment, in operation 620, the electronic device may identify, in the displayable area, a first area in which the external display is disposed and a second area which corresponds to a remaining area excluding the first area, based on at least a portion of the external display being excluded from the displayable area due to movement of the external display.

According to an embodiment, the external display may have an area excluding from the displayable area even in case that there is no area blocked due to movement of the external display, such as a window of a building. According to an embodiment, the external display may be at least partially blocked by a surrounding vehicle body or housing depending on movement of the external display, such as a window of a vehicle or a rollable display.

According to an embodiment, the electronic device may identify movement of the external display based on at least one of an image acquired through the camera or sensor data acquired through at least one sensor 176 (e.g., the sensor module 176 in FIG. 1, the camera module 180 in FIG. 1, the second camera module 253 in FIG. 2, the third camera module 255 in FIG. 2, the camera modules 311, 312, 313, 314, 315, and 316 in FIG. 3, or the depth sensor 317 in FIG. 3).

According to an embodiment, in case that a portion of the external display is excluded from the displayable area in a state in which the external display is completed closed as the external display (e.g., a window) is moved (e.g., rolled down or opened), the electronic device may identify an area in which the external display is located of the displayable area as a first area. The electronic device may identify, as a second area, an area in the displayable area, in which the external display is not located as the external display is moved. The second area may correspond to a remaining area excluding the first area from the displayable area.

According to an embodiment, in case that only a portion of the external display is exposed and a remaining area is blocked by a housing, a sash, or a wall as the external display (e.g., a window) is moved (e.g., rolled down or opened), the electronic device may identify an area of the displayable area, through which the external display is exposed as a first area. The electronic device may identify, as a second area, an area in the displayable area, in which the external display is not located as the external display is moved. The second area may correspond to a remaining area excluding the first area from the displayable area.

According to an embodiment, the electronic device may receive information related to movement of the external display from the external electronic device connected through at least the communication module comprising communication circuitry. For example, the information related to movement of the external display may include at least one of information related to whether the external display is moved, information related to a movement distance of the external display, or information about a size of a partial area of the external display exposed by movement of the external display.

According to an embodiment, the electronic device may identify the first area and the second area included in the displayable area based on the information related to movement of the external display.

According to an embodiment, the electronic device may identify (or calculate) a location and a direction of the electronic device within the space by using at least one of the received space data, distance information from the external display, and information acquired by recognizing an image acquired through the camera, and based thereon, display a content and information in real time on the first area and/or the second area of the displayable area matching the external display in the actual space.

According to an embodiment, the operation of receiving information related to movement of the external display from the external electronic device will be described in detail with reference to FIG. 14 below.

According to an embodiment, the electronic device may display an indicator with respect to at least one of the displayable area, the first area, or the second area. For example, the electronic device may display a border of the displayable area, a border of the first area, and/or a border of the second area. For example, the electronic device may display the border of the displayable area, the border of the first area, and/or the border of the second area with different colors.

According to an embodiment, the electronic device may display the displayable area, the first area, and/or the second area with different colors.

According to an embodiment, in operation 630, the electronic device may display a virtual screen on the second area.

According to an embodiment, the external display may be displaying a first content.

According to an embodiment, the electronic device may receive information related to the first content being displayed on the external display from the external electronic device configured to control the external display connected through the communication module comprising communication circuitry. According to an embodiment, the electronic device may display the received information related to the first content on at least a portion of the displayable area.

According to an embodiment, the electronic device may receive the first content being displayed on the external display from the external electronic device configured to control the external display connected through at least the communication module. The electronic device may display a portion of the received first content corresponding to the second area as a virtual screen on the second area. For example, based on movement of the external display, the first content may be displayed on the first area of the displayable area by the external display and the first content may be displayed on the second area as a virtual screen by the electronic device.

According to an embodiment, the electronic device may output a virtual screen (or light source or image) on the second area through a light output module (e.g., a projector) (e.g., the light output module 211 in FIG. 2) disposed on the housing (e.g., a glasses frame). According to an embodiment, the virtual screen may be reflected and/or diffracted by the second area to be guided to the user's eye.

As such, the electronic device may provide continuous content viewing experience before and after the external display is moved.

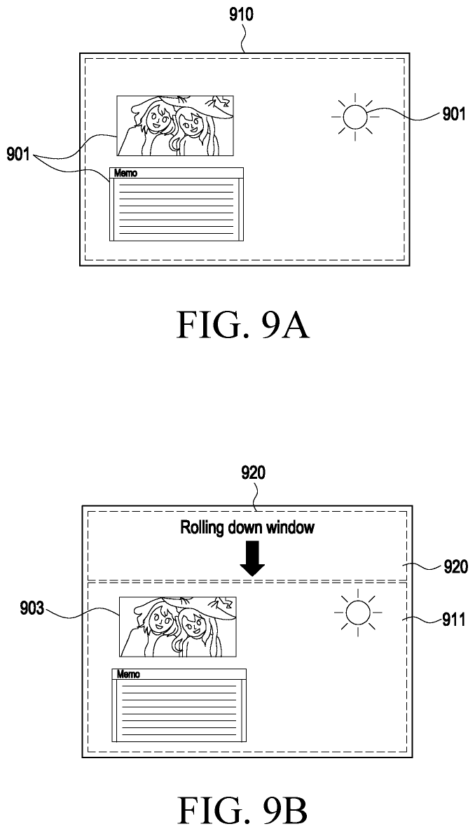

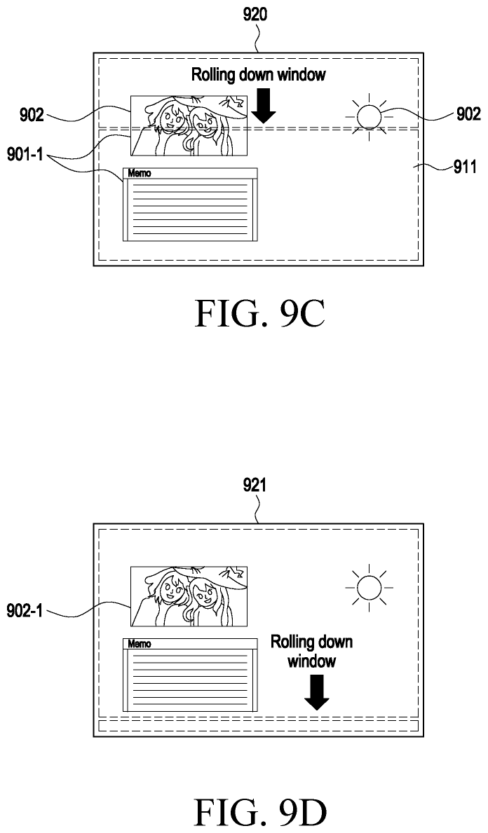

According to an embodiment, the operation of displaying one content through the external display and the electronic device will be described in detail with reference to FIGS. 9B, 10, and 11B below.

According to an embodiment, the electronic device may display the first content received from the external electronic device on the displayable area as a virtual screen. For example, a display operation of the external display may be stopped and the first content may be displayed on the entire displayable area as a virtual screen by the electronic device. As such, the electronic device may provide continuous content viewing experience before and after the external display is moved.

According to an embodiment, the electronic device may display, as a virtual screen, a content on the displayable area before the external display is moved. According to an embodiment, in case that the external display is moved, the electronic device may maintain the operation of displaying the content on the displayable area.

According to an embodiment, in case that one content is displayed through the first area and the second area after the external display is moved, the second area in which the external display is not disposed, and the first area may have different brightness. According to an embodiment, the electronic device may control brightness of the virtual screen of the second area based on the brightness of the first area. For example, the electronic device may acquire brightness information of the first area through a sensor and/or a camera. According to an embodiment, the brightness information of the first area may correspond to information to which a brightness value of a content displayed on the first area and a brightness value of an external environment (e.g., weather and illuminance) are reflected.

According to an embodiment, the electronic device may control a brightness value of the virtual screen of the second area to correspond to a brightness value of the first area, based on the brightness information of the first area.

According to an embodiment, the electronic device may display information related to an external environment on the second area, based on movement of the external display which is displaying the first content. For example, as the external environment is exposed to the second area due to movement of the external display, the electronic device may display information related to the external environment as a virtual object (e.g., a virtual screen) on the second area. For example, the information related to the external environment may include at least one of temperature information, weather information (e.g., weather, rainfall, humidity, or wind strength), fine dust information, information related to a building visible through the second area, or an image acquired by capturing the outside. According to an embodiment, the electronic device may display the information related to the external environment together with environment information (e.g., a temperature or humidity) of the interior of the vehicle, or further include peripheral information (e.g., local service information, a road condition (e.g., congestion, a speed limit, a road name, or a navigation route)) related to a location thereof.

According to an embodiment, the electronic device may display the first content as a virtual screen on the first area, based on movement of the external display which is displaying the first content. For example, the electronic device may display information related to the external environment as a virtual screen on the second area and adjust the entire first content to match a size of the first area and display the adjusted first content as a virtual screen on the first area. According to an embodiment, in case that the electronic device displays the first content having an adjusted size as a virtual screen on the first area, a display operation of the external display may be stopped.

According to an embodiment, based on movement of the external display which is displaying the first content, in case that a size of the first area is less than a configured value, the electronic device may adjust the entire first content to match a size of the first area and display the adjusted first content as a virtual, and transmit a command to the external display device to stop the display operation. According to an embodiment, the configured value of the size of the first area may be configured by a manufacturer or the user.

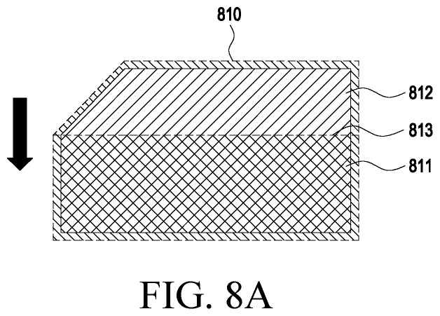

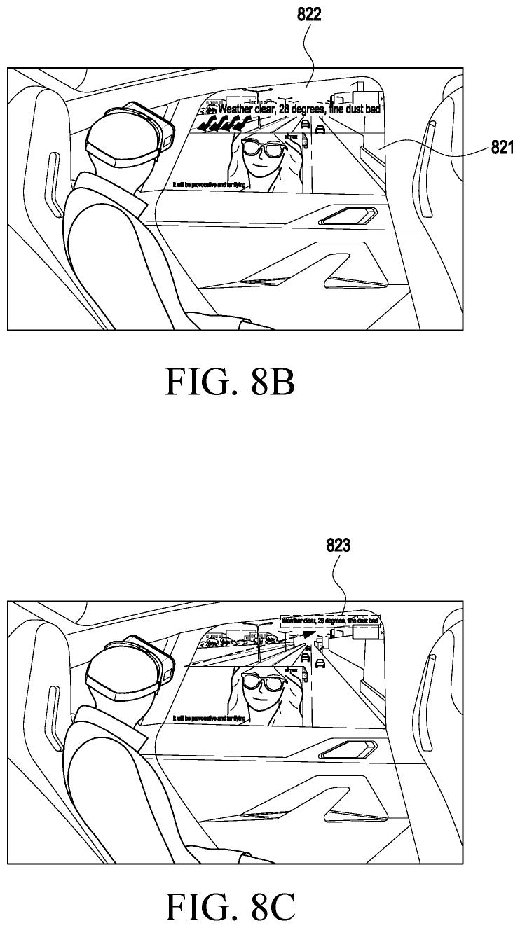

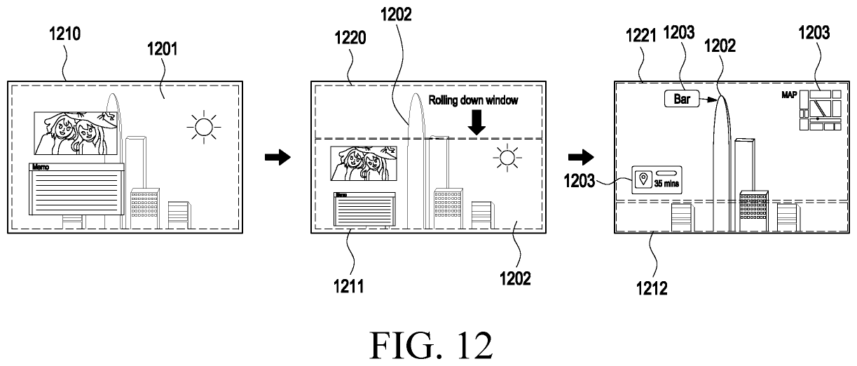

According to an embodiment, an operation of displaying information related to the external environment on the second area in which the external display is not disposed due to movement of the external display will be described with reference to FIGS. 8B and 12 below.

According to an embodiment, based on detection of a user's gaze with respect to the second area through at least one sensor, the electronic device may display information related to the external environment as a virtual screen on the first area. For example, in case that the user's gaze toward the second area is detection in a state in which information related to the external environment is displayed as a virtual screen on the second area in which the external display is not disposed due to movement of the external display and on the first area, a content is displayed by the external display device or a content is displayed as a virtual screen by the electronic device, the electronic device may display the information related to the external environment as a virtual screen on the first area. As such, by changing the virtual screen based on the user's gaze, the electronic device may provide a content of interest to the user.

According to an embodiment, the electronic device may display an indicator indicating that the user's gaze is directed to the area where the user's gaze is detected.

According to an embodiment, the operation of controlling the display of the virtual screen based on the user's gaze will be described in detail with reference to FIG. 8c below.

According to an embodiment, based on the first area, in which the external display is disposed in the displayable area, having a size less than a configured size, the electronic device may display, as a virtual screen on the first area, another content different from a content previously displayed on the external display.

According to an embodiment, the external electronic device configured to control the external display may stop outputting a content in case that the first area of the external display has a size less than a configured size. According to an embodiment, in case of identifying that the outputting content is stopped through the external display as the first area, in which the external display is disposed in the displayable area, becomes to have a size less than a configured size, the electronic device may display, as a virtual screen on the first area, another content different from a content previously displayed on the external display.

According to an embodiment, as the first area, in which the external display is disposed in the displayable area, becomes to have a size less than a configured size, the electronic device may transmit a command to the control device configured to control the external display to stop outputting content. According to an embodiment, in case of identifying that the outputting content is stopped through the external display, the electronic device may display, as a virtual screen on the first area, another content different from a content previously displayed on the external display.

According to an embodiment, in case that the first area, in which the external display is disposed in the displayable area, becomes to have a size less than a configured size, the electronic device may display, as a virtual screen on the first area, another content different from a content previously displayed on the external display regardless of whether a content is displayed on the external display.

For example, in case that the first area has a size less than a configured value (e.g., about 20% of the displayable area), the electronic device may display, as a virtual screen on the first area, a user interface (UI) configured to control a music reproduction application being executed on the electronic device or the external electronic device.

Therefore, it is possible to utilize a small-sized area of the external display where it is difficult to display a content such as video.

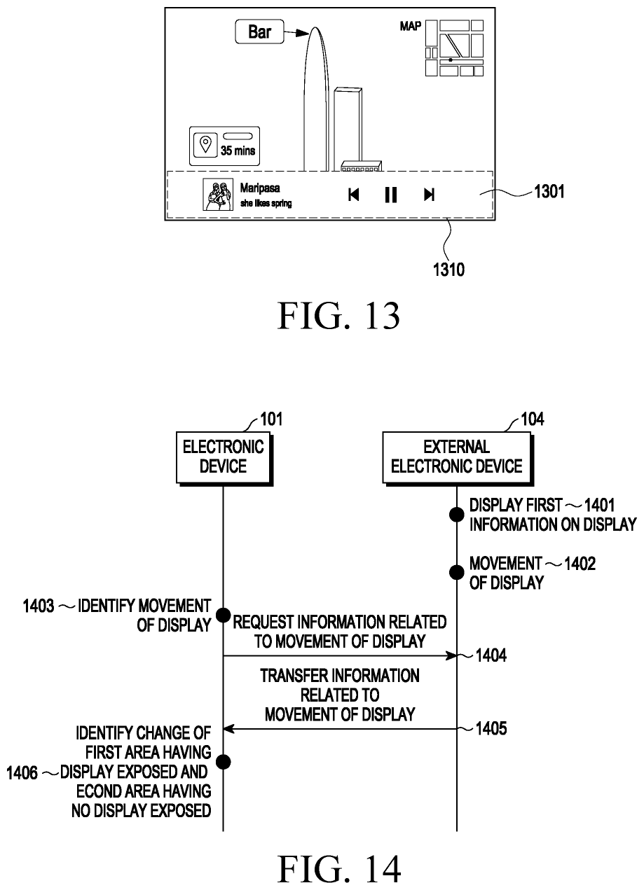

According to an embodiment, an embodiment in which a virtual screen including another function based on the size of the first area is displayed will be described in detail with reference to FIG. 13 below.

As such, in case of watching a content on a moving structure by using a wearable device, the content may be changed and provided in real time according to movement of the structure.

FIG. 7A is a diagram illustrating an operation of an electronic device for identifying a displayable area based on an external display according to an embodiment.

Referring to FIG. 7A, the electronic device (or the wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a displayable area 710. For example, the displayable area 710 may correspond to a maximum area or large in which a content may be displayed by the external display. For example, in case that the external display corresponds to a window of the vehicle, the displayable area may correspond to an area in which the window is disposed with the window closed.

According to an embodiment, the electronic device may identify the displayable area, based on space data (e.g., 3D data) received from an external electronic device (e.g., the electronic device 104 in FIG. 1). For example, the space data may be related to a structure inside the vehicle, such as a seating position, a seat type, a window location and/or window shape.

According to an embodiment, the electronic device may identify the displayable area 710 based on an image acquired through the camera (e.g., the camera module 160 in FIG. 1, the second camera module 253 in FIG. 2, the third camera module 255 in FIG. 2, the camera modules 311, 312, 313, 314, 315, and 316 in FIG. 3, or the depth sensor 317 in FIG. 3). For example, the electronic device may recognize the image acquired through the camera, recognize the external display (e.g., a window) included in the image, and identify an area corresponding to the external display as the displayable area. According to an embodiment, the electronic device may acquire space data (e.g., 3D data) based on the image acquired through the camera and determine an external display area identified based on space data as the displayable area.

FIG. 7B is a diagram illustrating an embodiment in which a first content is displayed on a displayable area according to an embodiment.

Referring to FIG. 7B, a first content 711 may be displayed on the displayable area. For example, the first content 711 may be displayed on the external display by control of the external electronic device.

According to an embodiment, the first content 711 may include image data.

According to an embodiment, the first content 711 may correspond to a virtual screen displayed on a display (e.g., the display module 160 in FIG. 1, the display member 201 in FIG. 2, the display 321 in FIG. 4, or the display member 440 in FIG. 5) by the electronic device. For example, the electronic device may display the first content 711 as a virtual screen on the displayable area corresponding to an area matching the external display.

FIG. 8A is a diagram illustrating an operation of an electronic device for identifying a displayable area as a first area and a second area based on movement of an external display according to an embodiment.

Referring to FIG. 8A, the electronic device (or a wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a displayable area 810 which corresponds to an external display through recognizing data (e.g., 3D data) received from the external electronic device (e.g., the electronic device 104 in FIG. 1) and/or an image acquired by a camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3).

According to an embodiment, as the external display is moved, a portion of the external display may be blocked by a housing, a sash, and/or a wall.

According to an embodiment, as the external display is moved, the displayable area 810 may include a first area 811 in which a portion of the external display is disposed and a second area 812 corresponding to a remaining area excluding the first area 811. The second area 812 corresponding to an area in which the external display is not disposed may correspond to an area exposed to an external environment.

According to an embodiment, the first area 811 and the second area 812 may be divided based on an edge of the external display. According to an embodiment, based on the edge of the external display, an area where an image may be output through the external display may be divided into the first area 811, and the remaining area may be divided into the second area 812.

FIG. 8B is a diagram illustrating an operation of an electronic device for displaying a virtual screen on at least a portion of a displayable area according to an embodiment.

Referring to 8B, the electronic device may display a virtual screen on the second area 822 in which the external display is not disposed. For example, the electronic device may display information related to the external environment as a virtual screen. According to an embodiment, the external environment may include an outer space not inner space of the external display, in which the electronic device is disposed. For example, the information related to the external environment may include at least one of temperature information, weather information (e.g., weather, rainfall, humidity, or wind strength), or fine dust information of a region in which the electronic device is located, information related to a building visible through the second area 822, or an image acquired by capturing the outside. According to an embodiment, the information related to the external environment may display the information related to the external environment together with environment information (e.g., a temperature or humidity) of the interior of the vehicle, and may further include peripheral information (e.g., local service information, a road condition (e.g., congestion, a speed limit, a road name, or a navigation route)) related to a location thereof. According to an embodiment, the information related to the external environment may be received from a server (e.g., the server 108 in FIG. 1).

According to an embodiment, the second area 822 has no external display disposed thereon and is exposed to the external environment and instead of displaying an image acquired by capturing the outside as a virtual screen on the second area 822, the external environment may be viewed through the virtual screen. For example, the electronic device may output a virtual screen with high transparency through the second area 822 and accordingly, the external environment may be viewed through the virtual screen.

According to an embodiment, the electronic device may output a virtual screen (or light source or image) on the second area 822 through a light output module (e.g., a projector) (e.g., the light output module 211 in FIG. 2) disposed on the housing (e.g., a glasses frame). According to an embodiment, the virtual screen may be reflected and/or diffracted by the second area 822 to be guided to the user's eye.

According to an embodiment, a content may be displayed by the external display on the first area 821 in which the external display is disposed. For example, the content may have been adjusted in size based on the size of the first area 821. According to an embodiment, an area of the first area 821 having no content displayed thereon corresponds to transparent glass and the external environment may be viewed therethrough.

According to an embodiment, the electronic device may display a virtual screen on the first area 821 as well. For example, the electronic device may receive information related to a content from the external electronic device and display virtual information based on the received information on the first area. According to an embodiment, the electronic device may generate virtual information (e.g., a virtual object) to be displayed on the first area based on the received information.

According to an embodiment, the electronic device may generate a virtual object (e.g., a virtual screen) based on the content received from the external electronic device and display the generated virtual object on the first area 821.

FIG. 8C is a diagram illustrating an operation of an electronic device for displaying a virtual screen on at least a portion of a displayable area based on user eye tracking according to an embodiment.

Referring to FIG. 8C, when it is detected that the user's gaze is directed to the second area exposed to the external environment through at least one sensor (e.g., the sensor module 176 in FIG. 1 or the first camera module 251 in FIG. 2), the electronic device may reduce a size of the virtual screen 823 including information related to the external environment. Based on the reduction of the size of the virtual screen 823, the external environment may be exposed through the second area.

According to an embodiment, when it is detected that the user's gaze is directed to the second area, the electronic device may receive an image capturing the external environment from the external electronic device and display the received image as a virtual screen on the second area. According to an embodiment, the electronic device may receive information related to movement of the external display from the external electronic device together with the image capturing the external environment. Based on the user's gaze and the information related to movement of the external display, the electronic device may crop a partial area of the image and display same as a virtual screen on the second area.

FIG. 9A is a diagram illustrating an operation of an electronic device for displaying a first content on an entire displayable area according to an embodiment.

Referring to FIG. 9A, the electronic device (or a wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a displayable area 910 which corresponds to an external display through recognizing data (e.g., 3D data) received from the external electronic device (e.g., the electronic device 104 in FIG. 1) and/or an image acquired by a camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3).

According to an embodiment, a first content 901 may be displayed on the displayable area 910. For example, the first content 901 may be displayed on the external display by control of the external electronic device.

According to an embodiment, in case that a display (e.g., the display module 160 in FIG. 1, the display member 201 in FIG. 2, the display 321 in FIG. 4, or the display member 440 in FIG. 5) of the electronic device corresponds to a display that transmits light of an actual space, the external display and the first content 901 being displayed on the external display may be displayed to the user through the display of the electronic device.

According to an embodiment, in case that the display of the electronic device does not transmit light of the actual space, the electronic device may display an image of the actual space acquired by the camera on the display. For example, the image displayed by the display may include the first content 901 being displayed by the external display.

FIG. 9B is a diagram illustrating an operation in which a content is displayed on a partial area of a displayable area based on movement of an external display according to an embodiment.

Referring to FIG. 9B, a partial area of the external display may be blocked due to movement (e.g., rolling down a window) of the external display. According to an embodiment, due to the movement of the external display, the displayable area may include a first area 911 in which the external display is disposed and a second area 920 in which the external display is not disposed.

According to an embodiment, a content 903 having a size adjusted to match the size of the first area 911 may be displayed on the first area 911 by the external display. According to an embodiment, in case that a portion of the displayable area is excluded as the external display is moved, the external electronic device may adjust a size of a content (e.g., the first content 901 in FIG. 9A) to match the size of the first area 911 of the displayable area, which may display an image, and display the content 903 having the adjusted size on the first area 911 of the external display.

FIG. 9C is a diagram illustrating an operation of an electronic device for displaying a virtual screen on at least a portion of a displayable area based on movement of an external display according to an embodiment.

Referring to FIG. 9C, a partial area of the external display may be blocked due to movement (e.g., rolling down a window) of the external display. According to an embodiment, due to the movement of the external display, the displayable area may include a first area 911 in which the external display is disposed and a second area 920 in which the external display is not disposed.

According to an embodiment, a portion 901-1 of the content 901 shown in FIG. 9A, which correspond to the first area 911 may be displayed on the first area 911 by the external display. According to an embodiment, in case that a portion of the displayable area is excluded as the external display is moved, the external electronic device may display the portion 901-1 corresponding to the first area 911 among the content (e.g., the first content 901 in FIG. 9A) on the first area 911 of the displayable area, which may display an image.

According to an embodiment, the electronic device may display a portion 902 corresponding to the second area 920 among the content (e.g., the first content 901 in FIG. 9A) on the second area 920. For example, the electronic device may generate virtual information (e.g., a virtual screen0 based on the portion 902 corresponding to the second area 920 among the content and display the generated virtual information on the second area 920.

According to an embodiment, the electronic device may output a virtual screen (or light source or image) on the second area 920 through a light output module (e.g., a projector) (e.g., the light output module 211 in FIG. 2) disposed on the housing (e.g., a glasses frame). According to an embodiment, the virtual screen may be reflected and/or diffracted by the second area 920 to be guided to the user's eye.

According to an embodiment, the electronic device may acquire brightness information of the first area 911 through a sensor and/or a camera. According to an embodiment, the brightness information of the first area 911 may correspond to information to which a brightness value of a content 901-1 displayed on the first area 911 and a brightness value of an external environment (e.g., weather and illuminance) are reflected.

According to an embodiment, the electronic device may control a brightness value of the virtual screen of the second area 920 to correspond to a brightness value of the first area 911, based on the brightness information of the first area 911.

As such, the electronic device may provide continuous content viewing experience before and after the external display is moved.

According to an embodiment, based on the movement of the external display, the content may be displayed in an adjusted size as shown in 9B or one content may be displayed through the external display and the virtual screen of the electronic device as shown in 9C.

According to an embodiment, in case that the size of the first area is equal to or greater than a configured size, the content may be displayed in an adjusted size as shown in FIG. 9B and, in case that the size of the first area is less than the configured size, one content may be displayed through the external display and the virtual screen of the electronic device as shown in FIG. 9C.

FIG. 9D is a diagram illustrating an operation of an electronic device for displaying a virtual screen on at least a portion of a displayable area based on movement of an external display according to an embodiment.

Referring to FIG. 9D, in case that the size of the first area is less than the configured size, based on the movement of the external display, an output of the external display may be stopped. According to an embodiment, the electronic device may display a portion 902-1 corresponding to the second area 921 among the content 901 shown in FIG. 9A on the second area 921.

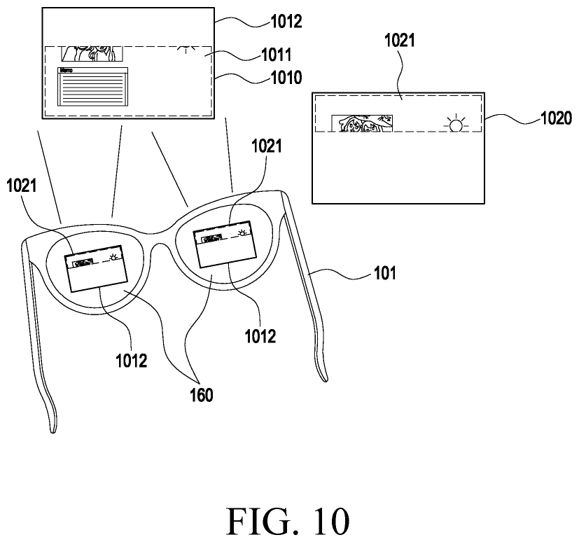

FIG. 10 is a diagram illustrating an operation of an electronic device for displaying a virtual screen on at least a portion of a displayable area based on movement of an external display according to an embodiment.

Referring to FIG. 10, based on movement of the external display on which a first content is being displayed, in a state in which a portion of the external display is blocked, a portion 1011 corresponding to partial area 1010 among the first content may be displayed on the exposed partial area 1010 of the external display. For example, the partial area 1010 of the external display may correspond to an area on which an image may be displayed among the displayable area 1012.

According to an embodiment, the electronic device (or a wearable electronic device) 101 (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a first area 1010 in which the external display is disposed and a second area 1020 in which the external display is not disposed based on a camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3) or movement information of the external display received from the external electronic device.

According to an embodiment, the electronic device 101 may control a display 160 (e.g., the display module 160 in FIG. 1, the display member 201 in FIG. 2, the display 321 in FIG. 4, or the display member 440 in FIG. 5) to display a portion 1021 corresponding to the second area 1020 among the first content as a virtual screen in the second area 1020.

According to an embodiment, in case that the display 160 of the electronic device corresponds to a display that transmits light of an actual space, the external display and a portion 1011 corresponding to the partial area 1010 among the first content being displayed on the external display may be displayed to the user through the display 160 of the electronic device. According to an embodiment, the electronic device may display only a virtual screen of a portion 1021 corresponding to the second area 1020 through the display 106.

According to an embodiment, in case that the display 160 of the electronic device does not transmit light of the actual space, the electronic device may display an image of the actual space acquired by the camera on the display. For example, the image displayed by the display may include the portion 1011 corresponding to the partial area 1010 of the external display and the first content being displayed on the external display. According to an embodiment, the electronic device may display, through the display 106, a virtual screen of the portion 1011 corresponding to the partial area 1010 among the first content being displayed on the external display and the portion 1021 corresponding to the second area 1020. According to an embodiment, the electronic device may output a virtual screen (or light source or image) on the second area 1020 through a light output module (e.g., a projector) (e.g., the light output module 211 in FIG. 2) disposed on the housing (e.g., a glasses frame). According to an embodiment, the virtual screen may be reflected and/or diffracted by second area 1020 of the display 160 to be guided to the user's eye.

As such, by displaying one content through the displaying of the external display and the virtual screen of the electronic device, the electronic device may provide continuous content viewing experience before and after the external display is moved.

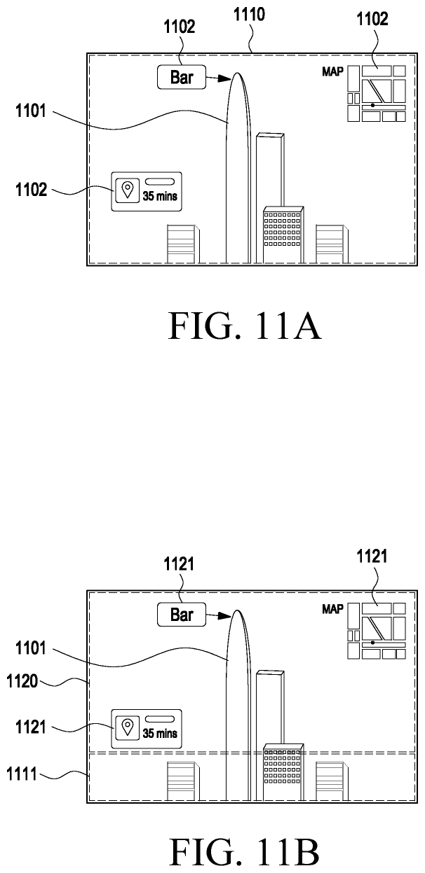

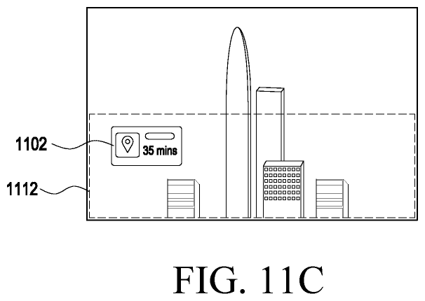

FIG. 11A is a diagram illustrating an operation of an electronic device for displaying a first content on an entire displayable area according to an embodiment.

Referring to FIG. 11A, the electronic device (or a wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a displayable area 1010 which corresponds to an external display through recognizing data (e.g., 3D data) received from the external electronic device (e.g., the electronic device 104 in FIG. 1) and/or an image acquired by a camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3).

According to an embodiment, the external environment 1101 viewed through the external display and the first content 1102 (e.g., information about the external environment) may be displayed on the displayable area 1010 by the external display. For example, the external environment 1101 may correspond to a building and the first content 1102 may include information related to the building. For example, the information related to the building may include at least one of building information (e.g., a building name, or a building size (height)), restaurant information in the building (e.g., a restaurant name, a restaurant type, or a phone number), information about a time taken to get to the building, and path information to the building (e.g., a path map).

According to an embodiment, the first content 1102 may include advertisement information related to the building and/or a restaurant within the building. For example, the information related to the building may be displayed around the building or partially overlaid on the building. According to an embodiment, the advertisement information related to the restaurant may be displayed around the building or partially overlaid on the building, based on a position of the restaurant within the building.

According to an embodiment, the first content 1102 may include advertisement information (e.g., a public interest advertisement or an external advertisement) unrelated to the building. According to an embodiment, the advertisement information unrelated to the building may be displayed around the building or partially overlaid on the building.

According to an embodiment, in case that a portion of an exterior wall of the building includes a space for advertisement, the electronic device may display the advertisement information overlaid on the space for advertisement.

According to an embodiment, the electronic device may display an image acquired by the camera on a display (e.g., the display module 160 in FIG. 1, the display member 201 in FIG. 2, the display 321 in FIG. 4, or the display member 440 in FIG. 5). For example, the image displayed by the display may include the first content 1102 and the external environment 1101 viewed through the external display.

FIG. 11B is a diagram illustrating an operation of an electronic device for displaying a virtual screen on at least a portion of a displayable area based on movement of an external display according to an embodiment.

Referring to FIG. 11B, a partial area of the external display may be blocked due to movement (e.g., rolling down a window) of the external display. According to an embodiment, due to the movement of the external display, the displayable area may include a first area 1111 in which the external display is disposed and a second area 1120 in which the external display is not disposed.

According to an embodiment, the electronic device may display the information 1121 about the external environment 1101 as a virtual screen on the second area 1120. According to an embodiment, the electronic device may output a virtual screen (or light source or image) on the second area 1120 through a light output module (e.g., a projector) (e.g., the light output module 211 in FIG. 2) disposed on the housing (e.g., a glasses frame). According to an embodiment, the virtual screen may be reflected and/or diffracted by the second area 1120 to be guided to the user's eye.

For example, the information 1121 about the external environment may be received from a server (e.g., the server 108 in FIG. 1) or received from an external electronic device (e.g., the electronic device 104 in FIG. 1) configured to control the external display, or may be acquired by capturing information displayed by the external display as shown in FIG. 11A.

FIG. 11C is a diagram illustrating an operation of an electronic device for displaying a virtual screen on at least a portion of a displayable area based on movement of an external display according to an embodiment.

Referring to FIG. 11C, the electronic device may not display a virtual screen on an area in which the external display is not disposed, depending on movement of the external display. According to an embodiment, the external electronic device may display, based on a position of the information 1102 about the external environment shown in FIG. 11A, only information 1102 about the external environment included in an area 1112 in which a portion of the external display is disposed according to movement of the external display. For example, no information may be displayed on the area in which the external display is not disposed according to movement of the external display.

According to an embodiment, among pieces of information 1102 about the external environment shown in FIG. 11A, the external electronic device may not display, pieces of information disposed on the area in which the external display is not disposed according to movement of the external display on the area 1112 in which a portion of the external display is disposed. According to an embodiment, the external electronic device may move a display position of the information 1102 about the external environment within the external display in a direction opposite to a direction of movement of the external display so as to maintain a position of information 1102 about the external environment included in the area 1112 in which a portion of the external display is disposed according to movement of the external display.

FIG. 12 is a diagram illustrating an operation of an electronic device for displaying a virtual screen on at least a portion of a displayable area based on movement of an external display according to an embodiment.

Referring to FIG. 12, the electronic device (or a wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a displayable area 1210 which corresponds to an external display through recognizing data (e.g., 3D data) received from the external electronic device (e.g., the electronic device 104 in FIG. 1) and/or an image acquired by a camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3).

According to an embodiment, a first content 1201 may be displayed on the displayable area 1210. For example, the first content 1201 may be displayed on the external display by control of the external electronic device.

According to an embodiment, in case that a display (e.g., the display module 160 in FIG. 1, the display member 201 in FIG. 2, the display 321 in FIG. 4, or the display member 440 in FIG. 5) of the electronic device corresponds to a display that transmits light of an actual space, the external display and the first content 1201 being displayed on the external display may be displayed to the user through the display of the electronic device.

According to an embodiment, in case that the display of the electronic device does not transmit light of the actual space, the electronic device may display an image of the actual space acquired by the camera on the display. For example, the image displayed by the display may include the first content 1201 being displayed by the external display.

According to an embodiment, a partial area of the external display may be blocked due to movement (e.g., rolling down a window) of the external display. According to an embodiment, due to the movement of the external display, the displayable area 1210 may include a first area 1211 in which the external display is disposed and a second area 1220 in which the external display is not disposed.

According to an embodiment, a content 1202 having a size adjusted to match the size of the first area 1211 may be displayed on the first area 1211 by the external display.

According to an embodiment, an external environment 1202 (e.g., a building) may be viewed in the second area 1220 exposed to the outside.

According to an embodiment, in case that the movement of the external display continues and the size of the first area 1212 becomes less than a configured size (e.g., about 20% of the displayable area 1210), the external display may stop outputting content. According to an embodiment, in case that the size of the first area 1212 is less than the configured size, the external display may stop outputting content by control of the external electronic device configured to control the external display. According to an embodiment, in case that the size of the first area 1212 is less than the configured size, the electronic device may transmit a command to stop outputting a content to the external electronic device configured to control the external display and the external electronic device configured to control the external display may stop outputting a content based on the received command.

According to an embodiment, in case that the size of the first area 1212 is less than the configured size (e.g., about 20% of the displayable area 1210), the electronic device may display a content different from the content 1201 or 1202 being output through the external display as a virtual object.

According to an embodiment, in case that the display of the electronic device corresponds to a display that transmits light of an actual space, the external environment 1202 viewed through the second area 1221 having a size equal to or greater than a configured value may be transmitted through the display of the electronic device to be shown to the user. According to an embodiment, the electronic device may display only the information 1203 about the external environment 1202 as a virtual object on the display. According to an embodiment, the electronic device may output a virtual object (or light source or image) on the second area 1221 through a light output module (e.g., a projector) (e.g., the light output module 211 in FIG. 2) disposed on the housing (e.g., a glasses frame). According to an embodiment, the virtual object may be reflected and/or diffracted by the second area 1221 to be guided to the user's eye.

According to an embodiment, in case that the display of the electronic device does not transmit light of the actual space, the electronic device may display an image, which is acquired through the camera, including the external environment 1202 viewed through the second area 1221 having the size equal to or greater than a configured size on the display and display the information 1203 about the external environment 1202 as a virtual object.

According to an embodiment, the electronic device may display, as a virtual screen, a content acquired by adjusting the size of the first content 1201 based on the size of the second area 1221 on the second area 1221 having the size equal to or greater than the configured value.

FIG. 13 is a diagram illustrating an operation of an electronic device for displaying a virtual screen on at least a portion of a displayable area based on movement of an external display according to an embodiment.

Referring to FIG. 13, the electronic device (or the wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may display, in case that the size of the first area 1310 in which the external display is disposed is less than a configured value due to movement of the external display, a content different from a content previously displayed on the external display on the first area as a virtual screen.

According to an embodiment, the external electronic device configured to control the external display may stop outputting a content in case that the first area of the external display has a size less than a configured size. According to an embodiment, in case of identifying that the outputting content is stopped through the external display as the first area, in which the external display is disposed in the displayable area, becomes to have a size less than a configured size, the electronic device may display, as a virtual screen on the first area, another content different from a content previously displayed on the external display.

According to an embodiment, as the first area, in which the external display is disposed in the displayable area, becomes to have a size less than a configured size, the electronic device may transmit a command to the control device configured to control the external display to stop outputting content. According to an embodiment, in case of identifying that the outputting content is stopped through the external display, the electronic device may display, as a virtual screen on the first area, another content different from a content previously displayed on the external display.

According to an embodiment, in case that the first area, in which the external display is disposed in the displayable area, becomes to have a size less than a configured size, the electronic device may display, as a virtual screen on the first area, another content different from a content previously displayed on the external display regardless of whether a content is displayed on the external display.

For example, a user interface (UI) 1301 configured to control a music reproduction application being executed in the electronic device or the external electronic device may be displayed on the first area 1310 as a virtual screen.

According to an embodiment, the electronic device may display, as a virtual screen, the information about the external environment on the second area in which the external display is not disposed.

According to an embodiment, in case that the size of the first area 1310 in which the external display is disposed is less than a configured value due to the movement of the external display, the UI 1301 configured to control the music reproduction application may be displayed on the external display by the external electronic device.

FIG. 14 is a flowchart illustrating an operation of an electronic device for acquiring information about movement of an external display according to an embodiment.

Referring to FIG. 14, in operation 1401, the external electronic device 104 (e.g., the electronic device 104 in FIG. 1) may display first information on the display of the external electronic device 104. For example, the first information may correspond to a content (e.g., an image).

According to an embodiment, in operation 1402, the external electronic device 104 may detect movement of the display. For example, the external electronic device may detect movement of the display based on a physical force such as input of a control command to move the display or manual control by the user. For example, the external electronic device 104 may detect, in case that the control command for moving the display based on the user input is input, movement of the display. According to an embodiment, the movement distance of the display may be detected based on a time during which the user input is retained.

According to an embodiment, the external electronic device 104 may detect whether the display moves through a sensor. According to an embodiment, the external electronic device 104 may detect a movement distance of the display through a sensor.

According to an embodiment, in operation 1403, the electronic device (or the wearable electronic device) 101 (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify movement of the display of the external electronic device 104.

For example, the electronic device 101 may recognize an image acquired through the camera (e.g., the camera module 160 in FIG. 1, the second camera module 253 in FIG. 2, the third camera module 255 in FIG. 2, the camera modules 311, 312, 313, 314, 315, and 316 in FIG. 3, or the depth sensor 317 in FIG. 3) and identify movement of the display of the external electronic device 104.

According to an embodiment, in operation 1404, the electronic device 101 may request information related to movement of the display of the external electronic device 104 from the external electronic device 104. For example, the information related to movement of the display of the external electronic device 104 may include a movement distance information and/or a movement direction information of the display of the external electronic device 104.

According to an embodiment, in operation 1405, the external electronic device 104 may transmit the information related to movement of the display of the external electronic device 104 to the electronic device 101.

According to an embodiment, in operation 1406, the electronic device 101 may identify a change of a first area through which the display of the external electronic device 104 is exposed and a second area through which the display is not exposed. For example, the first area may include a partial area of the display of the external electronic device 104 which is not blocked by movement of the display of the external electronic device 104. According to an embodiment, the second area may correspond to an area in which the display of the external electronic device 104 is disposed and in which the display of the external electronic device 104 is not disposed due to movement of the display of the external electronic device 104.

According to an embodiment, the external electronic device 104 may perform operation 1405 in case that movement of the display of the external electronic device 104 is detected even without operation 1404.

According to an embodiment, even without reception of the information related to movement of the display of the external electronic device 104 from the external electronic device 104, the electronic device 101 may identify movement of the display of the external electronic device 104 through at least one sensor and/or camera of the electronic device 101.

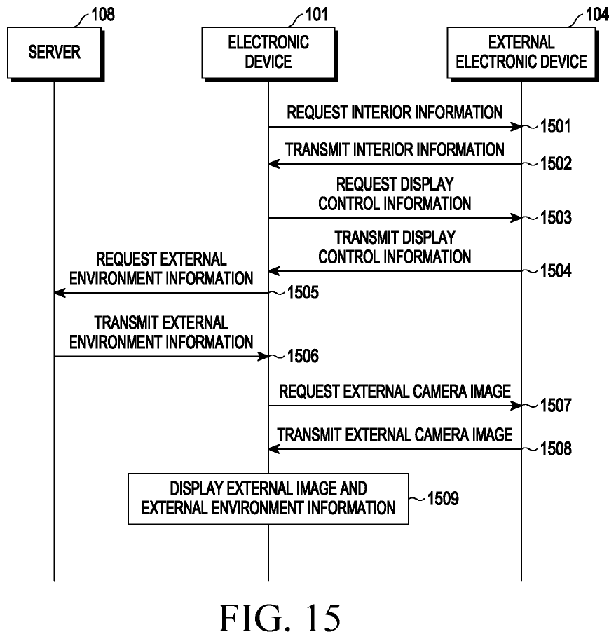

FIG. 15 is a flowchart illustrating an operation of an electronic device for displaying a virtual screen, based on movement of an external display according to an embodiment.

Referring to FIG. 15, in operation 1501, the electronic device (or the wearable electronic device) 101 (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may request interior information from the external electronic device 104 (e.g., the electronic device 104 in FIG. 1). For example, the interior information may be related to a structure inside the space, such as a seating position, a seat type, a window (or door) location and/or window shape.

According to an embodiment, when accessing or entering the external electronic device 104, the electronic device 101 may request the interior information from the external electronic device 104 through a near-field communication method, such as BT, BLE, UWB, and Wi-Fi.

According to an embodiment, the electronic device 101 may identify proximity to the external electronic device 104 through the BLE and identify an exact distance by using the UWB communication.

According to an embodiment, without direct communication connection with the external electronic device 104, the electronic device 101 may perform communication connection with a second external electronic device (e.g., a smartphone) having communication connection with the external electronic device 104.

According to an embodiment, in operation 1502, the external electronic device 104 may transmit the interior information to the electronic device 101.

According to an embodiment, the electronic device 101 may be connected to the external electronic device 104 through Wi-Fi, BT, UWB, and 5G networks, and may identify a location of the electronic device 101 within the external electronic device 104 (e.g., a vehicle) by using BT, a UWB, a driver monitoring system (DMS), and an occupant monitoring system (OMS).

According to an embodiment, in case that the interior information is requested in a state of wearing the electronic device 101, the external electronic device 104 may identify a location of the electronic device 101 and transmit data (e.g., 3D data) based on the location of the electronic device 101 to the electronic device 101.

According to an embodiment, the electronic device 101 may calculate a position of the electronic device 101 in a space through the received data, an image acquired through the camera (e.g., an RGB camera), and at least one sensor (e.g., a depth sensor, or radar).

According to an embodiment, in operation 1503, the electronic device 101 may request display control information from the external electronic device 104. For example, the display control information may include at least one of information related to the display of the external electronic device 104 is moved, information related to a movement distance of the display of the external electronic device 104, or information about a size of a partial area of the display of the external electronic device 104 exposed due to movement of the display of the external electronic device 104.

According to an embodiment, in operation 1504, the external electronic device 104 may transmit the display control information to the electronic device 101.

According to an embodiment, in operation 1505, the electronic device 101 may request external environment information from the server 108 (e.g., the server 108 in FIG. 1). For example, the external environment information may include at least one of temperature information, weather information, fine dust information, or information related to a building viewed through the display of the external electronic device 104 or viewed due to movement of the display of the external electronic device 104.

According to an embodiment, in operation 1506, the server 108 may transmit the external environment information to the electronic device 101.

According to an embodiment, in operation 1507, the electronic device 101 may request an external camera image from the external electronic device 104. For example, in case that the user's gaze is directed to the external environment, the electronic device 101 may request the external camera image from the external electronic device 104.

According to an embodiment, in operation 1508, the external electronic device 104 may transmit the external camera image to the electronic device 101.

According to an embodiment, in operation 1509, the electronic device 101 may display an external image and external environment information. For example, the electronic device 101 may display, as a virtual screen, the external image and external environment information on the second area and/or the first area of the displayable area in which the display of the external electronic device 104 is disposed.

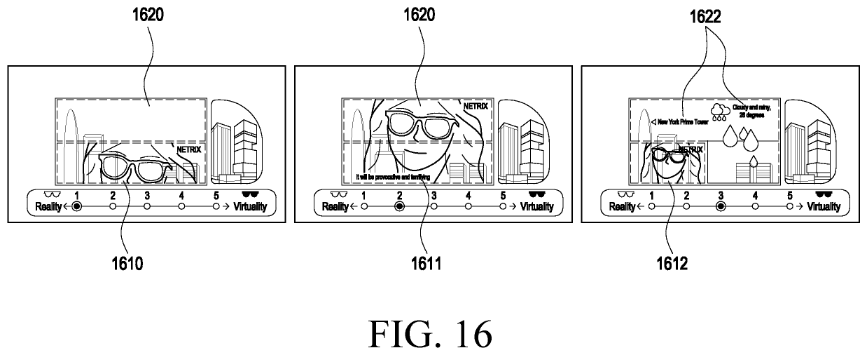

FIG. 16 is a diagram illustrating an operation of an electronic device for displaying a virtual screen on at least a portion of a displayable area based on movement of an external display according to an embodiment.

Referring to FIG. 16, the electronic device (or the wearable electronic device) 101 (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may determine a mixing level of a virtual screen displayed by the external display and the electronic device through a user input.

For example, in case that the mixing level may be selected from level 1 to level 5, as the level increases, a type and an amount of information included in the virtual screen may increase. In the highest level, the virtual screen may be displayed not only in the displayable area but also in a surrounding area.

By way of example, FIG. 16 illustrates a content from mixing level 1 to mixing level 3.

According to an embodiment, the electronic device may divide the displayable area into a first area in which the external display is disposed and a second area in which the external display is not disposed according to the movement of the external display.

According to an embodiment, in mixing level 1, the electronic device may display an image acquired by the camera on the display without displaying the virtual screen. For example, an image displayed on the display of the electronic device may include a content 1610 displayed on the first area by the external display and an external environment 1620 viewed through the second area having no external display.

According to an embodiment, in mixing level 2, the electronic device may display a virtual screen to continuously provide a content before and after movement even if the external display is moved.

For example, a portion 1611 corresponding to the first area among a first content having been displayed before the external display is moved may be displayed on the first area by the external display.

According to an embodiment, the electronic device may display a portion 1621 corresponding to the second area among the first content as a virtual screen on the second area.

According to an embodiment, an output of the external display may be stopped and the electronic device may display the first content on the first area and the second area as a virtual screen.

As such, by displaying one content through the external display and the virtual screen even after the external display is moved, continuous content viewing experience may be provided before and after the external display is moved.

According to an embodiment, in mixing level 3, information about the external environment may be output together with the content output.

For example, a content 1612 acquired by adjusting the first content having been displayed before the movement of the external display to correspond to the size of the first area may be displayed on a portion of the first area by the external display.

According to an embodiment, the electronic device may display a virtual screen 1622 on an area other than an area in which the content 1612 is displayed among the first area and the second area. For example, the virtual screen 1622 may include information about the external environment. For example, the information about the external environment may include at least one of temperature information, weather information, fine dust information, information related to a building visible through the second area, or an image acquired by capturing the outside.

FIG. 17 is a diagram illustrating an operation of an electronic device for displaying a virtual screen on at least a portion of a displayable area, based on movement of a sunroof in case that an external display corresponds to the sunroof according to an embodiment.

Referring to FIG. 17, the electronic device (or a wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a displayable area 1710 which corresponds to an external display (e.g., a sunroof) through recognizing data (e.g., 3D data) received from the external electronic device (e.g., the electronic device 104 in FIG. 1) and/or an image acquired by a camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3).

According to an embodiment, a partial area of the external display may be blocked due to movement (e.g., opening a sunroof) of the external display. According to an embodiment, due to the movement of the external display, the displayable area 1710 may include a first area 1711 in which the external display is disposed and a second area 1712 in which the external display is not disposed.

According to an embodiment, a content 1720 having a size adjusted to match the size of the first area 1711 may be displayed on the first area 1711 by the external display.

According to an embodiment, the electronic device may display the information 1721 related to the external environment as a virtual screen on the second area 1712 exposed to the outside. For example, the electronic device may display the information 1721 related to the external environment as a 3D virtual object. According to an embodiment, the electronic device may display information (e.g., a 3D map) related to a region of interest of the user as a virtual object on the second area 1712. According to an embodiment, the electronic device may output a virtual object (or light source or image) on the second area 1712 through a light output module (e.g., a projector) (e.g., the light output module 211 in FIG. 2) disposed on the housing (e.g., a glasses frame). According to an embodiment, the virtual object may be reflected and/or diffracted by the second area 1712 to be guided to the user's eye.

FIG. 18 is a diagram illustrating an operation of an electronic device for displaying a virtual screen on at least a portion of a displayable area according to an embodiment.

Referring to FIG. 18, the electronic device (or a wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a first displayable area 1810 corresponding to a first external display (e.g., a door) and a second displayable area 1820 corresponding to a second external display (e.g., a door) through recognizing data (e.g., 3D data) received from the external electronic device (e.g., the electronic device 104 in FIG. 1) and/or an image acquired by a camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3).

According to an embodiment, a content 1811 may be displayed on the displayable area 1810. For example, the content 1811 may be displayed on the external display by control of the external electronic device. For example, if the first external display corresponds to a door inside a building, the content 1811 may include weather information of the outside.

According to an embodiment, a content 1821 may be displayed on the second displayable area 1820. For example, the content 1821 may be displayed on the external display by control of the external electronic device. For example, if the first external display corresponds to a door inside a building, the content 1821 may include external environment information (e.g., an outside scenery).

According to an embodiment, in case that a display (e.g., the display module 160 in FIG. 1, the display member 201 in FIG. 2, the display 321 in FIG. 4, or the display member 440 in FIG. 5) of the electronic device corresponds to a display that transmits light of an actual space, the external display and a content 1811 or 1821 being displayed on the external display may be visible to the user through the display of the electronic device.

According to an embodiment, in case that the display of the electronic device does not transmit light of the actual space, the electronic device may display an image acquired by the camera on the display. For example, the image displayed by the display may include the content 1811 being displayed by the external display.

According to an embodiment, as a portion of the second external display is blocked by the first external display due to movement (e.g., the door is opened) of the second external display corresponding to the door, the second displayable area 1820 may include a first area 1820-1 in which the second external display is disposed and a second area 1830 in which the second external display is not disposed. According to an embodiment, on the first area 1820-1 in which the second external display is disposed, a portion corresponding to the first area 1820-1 among the content 1821 may be displayed by control of the external electronic device. According to an embodiment, content displaying may be stopped on a portion 1820-2 blocked by the first external display among the second external display by control of the second external display.

According to an embodiment, the electronic device may generate virtual information with respect to the portion among the content 1821 corresponding to the second area 1830 in which the external display is not disposed and display the generated virtual information on the second area 1830. According to an embodiment, the electronic device may output virtual information (or light source or image) on the second area through a light output module (e.g., a projector) (e.g., the light output module 211 in FIG. 2) disposed on the housing (e.g., a glasses frame). According to an embodiment, the virtual information may be reflected and/or diffracted by the second area to be guided to the user's eye.

According to an embodiment, in case that the second external display is completely excluded from the second displayable area 1820 as the second external display corresponding to the door is continuously moved (e.g., the second external display is entirely blocked due to the movement), the electronic device may generate virtual information corresponding to the entire content 1821 and display the generated virtual information on the second displayable area 1820.

According to an embodiment, a door open sensor may be installed at the door, and the electronic device may acquire, through the door open sensor, information related to movement of the door with which communication connection is established.

According to an embodiment, operations of FIG. 6 to FIG. 17 may be performed in the case of a door disposed inside a building.

The disclosure describes the case in which the external display is rolled down but is not limited thereto, and the disclosure may also be applied when the external display is moved upward, left, right, or diagonally, or other scenarios.

The disclosure describes the case in which one external display is moved in one direction but is not limited thereto, and the external display may include two or more pieces and may be movable left and right, up and down, or in three or more directions, or other scenarios. According to an embodiment, the number of the first area and the second area each may be plural, and the disclosure may be applied to the case in which there are multiple first areas and multiple second areas, or other scenarios.

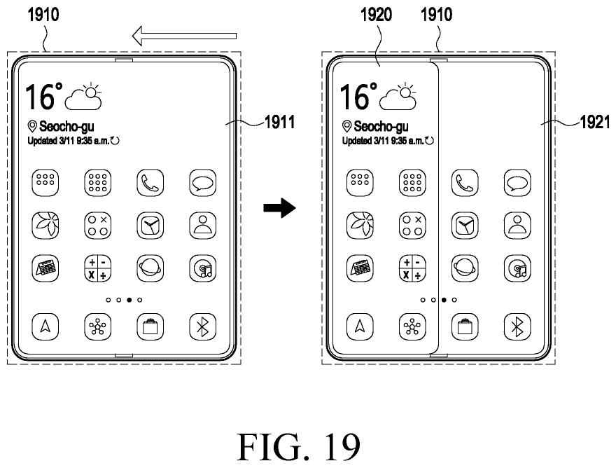

FIG. 19 is a diagram illustrating an operation of an electronic device for displaying a virtual screen on at least a portion of a displayable area, based on rolling of a rollable display in case that an external display corresponds to the rollable display according to an embodiment.

Referring to FIG. 19, the electronic device (or a wearable electronic device) (e.g., the electronic device 101 in FIG. 1, the wearable electronic device 200 in FIG. 2, the wearable electronic device 300 in FIG. 3, the wearable electronic device 300 in FIG. 4, or the electronic device 400 in FIG. 5) may identify a displayable area 1910 which corresponds to an external display (e.g., a rollable display) through recognizing data (e.g., 3D data) received from the external electronic device (e.g., the electronic device 104 in FIG. 1) and/or an image acquired by a camera (e.g., the camera module 160 in FIG. 1, the second camera module 253 in FIG. 2, the third camera module 255 in FIG. 2, the camera modules 311, 312, 313, 314, 315, and 316 in FIG. 3 or the depth sensor 317 in FIG. 3). According to an embodiment, the displayable area 1910 may correspond to an area in which an image may be displayed on a rollable display when the rollable display is fully extended.

According to an embodiment, a content 1911 may be displayed on the displayable area 1910. For example, the content 1911 may correspond to a screen displayed on the external display by control of the external electronic device. For example, in case that the external display corresponds to a rollable display, the content 1911 may include a screen (e.g., a home screen, and an application execution screen) of the external electronic device including the rollable display.

According to an embodiment, in case that the display of the electronic device corresponds to a display that transmits light of an actual space, the external display and the content 1911 being displayed on the external display may be displayed to the user through the display of the electronic device.

According to an embodiment, in case that the display 160 of the electronic device corresponds to a display that does not transmit light of an actual space, the electronic device may display an image acquired by the camera on the display (e.g., the display module 160 in FIG. 1, the display member 201 in FIG. 2, the display 321 in FIG. 4, or the display member 440 in FIG. 5). For example, the image displayed by the display may include the content 1911 being displayed by the external display.

According to an embodiment, as the external display which is a rollable display is moved (e.g., a door is opened), the displayable area 1910 may include a first area 1920 in which the external display is disposed and a second area 1921 in which the external display is not disposed. According to an embodiment, on the first area 1920 in which the external display is disposed, a portion corresponding to the first area 1920 among the content 1911 may be displayed by control of the external electronic device. According to an embodiment, the electronic device may generate virtual information with respect to the portion among the content 1911 corresponding to the second area 1921 in which the external display is not disposed and display the generated virtual information on the second area 1921. According to an embodiment, the electronic device may output virtual information (or light source or image) on the second area 1921 through a light output module (e.g., a projector) (e.g., the light output module 211 in FIG. 2) disposed on the housing (e.g., a glasses frame). According to an embodiment, the virtual information may be reflected and/or diffracted by the second area 1921 to be guided to the user's eye.

According to an embodiment, in case that the display of the electronic device corresponds to a display that transmits light of an actual space, the external display and a portion corresponding to the first area 1920 among the content 1911 being displayed on the external display may be displayed to the user through the display of the electronic device. According to an embodiment, the electronic device may display only the virtual screen of a portion among the content 1911 corresponding to the second area 1921, in which no external display is disposed, through the display.

According to an embodiment, in case that the display of the electronic device does not transmit light of the actual space, the electronic device may display an image of the actual space acquired by the camera on the display. For example, the image displayed by the display may include the external display and a portion corresponding to the first area 1920 among the content 1911 being displayed on the external display. According to an embodiment, the electronic device may display a portion corresponding to the first area 1920 among the content 1911 being displayed on the external display and the virtual screen of a portion corresponding to the second area 1921, in which no external display is disposed, among the content 1911 through the display.

According to an embodiment, a wearable electronic device may include memory, a camera, a display, and at least one processor operatively connected, directly or indirectly, to the memory, the camera, and the display.

According to an embodiment, the memory may store instructions which cause, when executed by the processor, the wearable electronic device to identify a displayable area corresponding to an external display included in an image of a space acquired through the camera.

According to an embodiment, the memory may store instructions which cause, when executed by the processor, the wearable electronic device to identify, based on at least a portion of the external display being excluded from the displayable area due to movement of the external display, a first area of the displayable area, in which a portion of the external display is disposed and a second area of the displayable area, which corresponds to a remaining area excluding the first area.

According to an embodiment, the memory may store instructions which cause, when executed by the processor, the wearable electronic device to control the display to display a virtual screen on the second area.

According to an embodiment, the wearable electronic device may further include at least one processor.

According to an embodiment, the memory may store instructions which cause, when executed by the processor, the wearable electronic device to identify movement of the external display based on at least one of sensor data acquired through the at least one sensor or an image acquired through the camera.

According to an embodiment, the memory may store instructions which cause, when executed by the processor, the wearable electronic device to identify the first area and the second area based on the movement of the external display.

According to an embodiment, the wearable electronic device may further include a communication module.

According to an embodiment, the memory may store instructions which cause, when executed by the processor, the wearable electronic device to receive information related to the movement of the external display from an external electronic device configured to control the external display connected through the communication module.

According to an embodiment, the memory may store instructions which cause, when executed by the processor, the wearable electronic device to identify the first area and the second area based on the information related to the movement of the external display.

According to an embodiment, the external display may correspond to at least one of a window or a sunroof of the vehicle, a window, or a rollable display.

According to an embodiment, the external electronic device may correspond to at least one of a control device of the vehicle configured to control the window or the sunroof of the vehicle, an external electronic device configured to control the window, or an external electronic device configured to control the rollable display.

According to an embodiment, the memory may store instructions which cause, when executed by the processor, the wearable electronic device to identify that the wearable electronic device is located withing the vehicle through the communication module.

According to an embodiment, the memory may store instructions which cause, when executed by the processor, the wearable electronic device to receive 3D data of the vehicle from the control device.

According to an embodiment, the memory may store instructions which cause, when executed by the processor, the wearable electronic device to identify the displayable area by further using the 3D data.

According to an embodiment, the memory may store instructions which cause, when executed by the processor, the wearable electronic device to receive a first content being displayed on the external display, from the external electronic device configured to control the external display connected through the communication module.

According to an embodiment, the memory may store instructions which cause, when executed by the processor, the wearable electronic device to display a portion corresponding to the second area among the received first content on the second area.

According to an embodiment, the memory may store instructions which cause, when executed by the processor, the wearable electronic device to receive a first content being displayed on the external display, from the external electronic device configured to control the external display connected through the communication module.

According to an embodiment, the memory may store instructions which cause, when executed by the processor, the wearable electronic device to display the received first content on the displayable area.

According to an embodiment, the memory may store instructions which cause, when executed by the processor, the wearable electronic device to display information related to an external environment on the second area based on movement of the external display which is displaying the first content.

According to an embodiment, the wearable electronic device may further include at least one processor.

According to an embodiment, the memory may store instructions which cause, when executed by the processor, the wearable electronic device to display virtual information related to the external environment on the second area, based on detection of the user's gaze with respect to the second area through the at least one sensor.

According to an embodiment, the memory may store instructions which cause, when executed by the processor, the wearable electronic device to control brightness of the virtual screen of the second area, based on brightness of the first area.

According to an embodiment, the memory may store instructions which cause, when executed by the processor, the wearable electronic device to display, as a virtual screen, another content different from a content previously displayed on the external display on at least a partial area including the first area among the displayable area, based on a size of the first area being less than a configured size.

According to an embodiment, a method for controlling a wearable electronic device may include an operation of identifying a displayable area corresponding to an external display included in an image of a space acquired through the camera of the wearable electronic device.

According to an embodiment, the method for controlling a wearable electronic device may include an operation of identifying, based on at least a portion of the external display being excluded from the displayable area due to movement of the external display, a first area of the displayable area, in which a portion of the external display is disposed and a second area of the displayable area, which corresponds to a remaining area excluding the first area.

According to an embodiment, the method for controlling a wearable electronic device may include an operation of displaying a virtual screen on the second area.

According to an embodiment, in the operation of identifying the first area and the second area corresponding to the remaining area excluding the first area among the displayable area, movement of the external display may be identified based on at least one of sensor data acquired through the at least one sensor of the wearable electronic device or an image acquired through the camera.

According to an embodiment, in the operation of identifying the first area and the second area corresponding to the remaining area excluding the first area among the displayable area, the first area and the second area may be identified based on the movement of the external display.

According to an embodiment, in the operation of identifying the first area and the second area corresponding to the remaining area excluding the first area among the displayable area, information related to the movement of the external display may be received from the external electronic device configured to control the external display.

According to an embodiment, in the operation of identifying the first area and the second area corresponding to the remaining area excluding the first area among the displayable area, the first area and the second area may be identified based on the information related to the movement of the external display.

According to an embodiment, the external display may correspond to at least one of a window or a sunroof of the vehicle, a window, or a sunroof.

According to an embodiment, the external electronic device may correspond to at least one of a control device of the vehicle configured to control the window or the sunroof of the vehicle, an external electronic device configured to control the window, or an external electronic device configured to control the rollable display.

According to an embodiment, in the operation of identifying the displayable area, it may be identified that the wearable electronic device is located in the vehicle through the communication module.

According to an embodiment, in the operation of identifying the displayable area, 3D data of the vehicle may be received from the control device.

According to an embodiment, in the operation of identifying the displayable area, the displayable area may be further identified by using the 3D data.

According to an embodiment, in the operation of identifying the displayable area and the operation of displaying the virtual screen on the second area, a first content being displayed on the external display may be received from the external electronic device configured to control the external display.

According to an embodiment, in the operation of identifying the displayable area and the operation of displaying the virtual screen on the second area, a portion corresponding to the second area among the received first content may be displayed on the second area.

According to an embodiment, in the operation of displaying the virtual screen on the second area, information related to the external environment on the second area may be displayed based on the movement of the external display which is displaying the first content.

According to an embodiment, the method for controlling a wearable electronic device may further include an operation of displaying virtual information related to the external environment on the first area, based on detection of the user's gaze with respect to the second area through the at least one sensor of the wearable electronic device.

According to an embodiment, in the operation of displaying the virtual screen on the second area, brightness of the virtual screen of the second area may be controlled based on the brightness of the first area.

According to an embodiment, a non-transitory computer readable recording medium storing at least one program may be provided, wherein the at least one program stores instructions which cause a wearable electronic device to identify a displayable area corresponding to an external display included in an image of a space acquired through the camera of the wearable electronic device.

According to an embodiment, the at least one program may store instructions which cause the wearable electronic device to identify, based on at least a portion of the external display being excluded from the displayable area due to movement of the external display, a first area of the displayable area, in which a portion of the external display is disposed and a second area of the displayable area, which corresponds to a remaining area excluding the first area.

According to an embodiment, the at least one program may store instructions which cause the wearable electronic device to control the display to display a virtual screen on the second area.

According to an embodiment, the wearable electronic device may further include at least one processor.

According to an embodiment, the at least one program may store instructions which cause the wearable electronic device to identify movement of the external display based on at least one of sensor data acquired through the at least one sensor or an image acquired through the camera.

According to an embodiment, the at least one program may store instructions which cause the wearable electronic device to identify the first area and the second area based on the movement of the external display.

According to an embodiment, the wearable electronic device may further include a communication module.

According to an embodiment, the at least one program may store instructions which cause the wearable electronic device to receive information related to the movement of the external display from an external electronic device configured to control the external display connected through the communication module.

According to an embodiment, the at least one program may store instructions which cause the wearable electronic device to identify the first area and the second area based on the information related to the movement of the external display.

“Based on” as used herein covers “based at least on”.

According to an embodiment, the external display may correspond to at least one of a window or a sunroof of the vehicle, a window, or a rollable display.

According to an embodiment, the external electronic device may correspond to at least one of a control device of the vehicle configured to control the window or the sunroof of the vehicle, an external electronic device configured to control the window, or an external electronic device configured to control the rollable display.

According to an embodiment, the at least one program may store instructions which cause the wearable electronic device to identify that the wearable electronic device is located withing the vehicle through the communication module.

According to an embodiment, the at least one program may store instructions which cause the wearable electronic device to receive 3D data of the vehicle from the control device.

According to an embodiment, the at least one program may store instructions which cause the wearable electronic device to identify the displayable area by further using the 3D data.

According to an embodiment, the at least one program may store instructions which cause the wearable electronic device to receive a first content being displayed on the external display, from the external electronic device configured to control the external display connected through the communication module.

According to an embodiment, the at least one program may store instructions which cause, when executed by the processor, the wearable electronic device to display a portion corresponding to the second area among the received first content on the second area.

According to an embodiment, the at least one program may store instructions which cause the wearable electronic device to receive a first content being displayed on the external display, from the external electronic device configured to control the external display connected through the communication module.

According to an embodiment, the at least one program may store instructions which cause the wearable electronic device to display the received first content on the displayable area.

According to an embodiment, the at least one program may store instructions which cause the wearable electronic device to display information related to an external environment on the second area based on movement of the external display which is displaying the first content.

According to an embodiment, the wearable electronic device may further include at least one processor.

According to an embodiment, the at least one program may store instructions which cause the wearable electronic device to display virtual information related to the external environment on the second area, based on detection of the user's gaze with respect to the second area through the at least one sensor.

According to an embodiment, the at least one program may store instructions which cause the wearable electronic device to control brightness of the virtual screen of the second area, based on brightness of the first area.

According to an embodiment, the at least one program may store instructions which cause the wearable electronic device to display, as a virtual screen, another content different from a content previously displayed on the external display on at least a partial area including the first area among the displayable area, based on a size of the first area being less than a configured size.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. A wearable electronic device comprising:
a camera;
a display;
at least one processor, comprising processing circuitry; and
memory storing instructions that, when executed by the at least one processor individually or collectively, cause the wearable electronic device to:
identify a displayable area corresponding to an external display included in an image of a space acquired through the camera;
identify, based on at least a portion of the external display being excluded from the displayable area due to movement of the external display, a first area of the displayable area, in which a portion of the external display is disposed, and a second area of the displayable area which corresponds to a remaining area excluding the first area; and
control the display to display a virtual screen on the second area.

2. The wearable electronic device of claim 1, further comprising at least one sensor,
wherein the instructions, when executed by the at least one processor individually or collectively, cause the wearable electronic device to:
identify the movement of the external display, based on at least one of sensor data acquired through the at least one sensor and/or the image acquired through the camera; and
identify the first area and the second area, based on the movement of the external display.

3. The wearable electronic device of claim 1, further comprising a communication module comprising communication circuitry,
wherein the instructions, when executed by the at least one processor individually or collectively, cause the wearable electronic device to:
receive information related to the movement of the external display from an external electronic device which is configured to control the external display and connected to the wearable electronic device through at least the communication module; and
identify the first area and the second area, based on the information related to the movement of the external display.

4. The wearable electronic device of claim 3,
wherein the external display corresponds to at least one of a window of a vehicle, a sunroof, a window, or a rollable display, and
the external electronic device is at least one of a control device of the vehicle, comprising processing circuitry, configured to control the window of the vehicle or the sunroof, an external electronic device comprising processing circuitry configured to control the window, or an external electronic device comprising processing circuitry configured to control the rollable display.

5. The wearable electronic device of claim 4, wherein the instructions, when executed by the at least one processor individually or collectively, cause the wearable electronic device to:
identify that the wearable electronic device is located in the vehicle through the communication module;
receive 3D data of the vehicle from the control device; and
identify the displayable area by further using the 3D data.

6. The wearable electronic device of claim 1, further comprising a communication module comprising communication circuitry,
wherein the instructions, when executed by the at least one processor individually or collectively, cause the wearable electronic device to:
receive a first content displayed on the external display from the external electronic device which is configured to control the external display and connected to the wearable electronic device through at least the communication module; and
display, on the second area, a portion corresponding to the second area among the received first content.

7. The wearable electronic device of claim 1, further comprising a communication module comprising communication circuitry,
wherein the instructions, when executed by the at least one processor individually or collectively, cause the wearable electronic device to:
receive a first content displayed on the external display from the external electronic device which is configured to control the external display and connected to the wearable electronic device through at least the communication module; and
display the received first content on the displayable area.

8. The wearable electronic device of claim 1, wherein the instructions, when executed by the at least one processor individually or collectively, cause the wearable electronic device to display information related to an external environment on the second area, based on movement of the external display which is displaying the first content.

9. The wearable electronic device of claim 8, further comprising at least one sensor,
wherein the instructions, when executed by the at least one processor individually or collectively, cause the wearable electronic device to display virtual information related to the external environment on the second area, based on detection of a user's gaze with respect to the second area through the at least one sensor.

10. The wearable electronic device of claim 1, wherein the instructions, when executed by the at least one processor individually or collectively, cause the wearable electronic device to control brightness of the virtual screen of the second area, based on brightness of the first area.

11. The wearable electronic device of claim 1, wherein the instructions, when executed by the at least one processor individually or collectively, cause the wearable electronic device to display, as a virtual screen, another content different from a content previously displayed on the external display on at least a partial area including the first area among the displayable area, based on a size of the first area being less than the configured size.

12. A method for controlling a wearable electronic device, the method comprising:
identifying a displayable area corresponding to an external display included in an image of a space acquired through a camera of the wearable electronic;
identifying, based on at least a portion of the external display being excluded from the displayable area due to movement of the external display, a first area of the displayable area, in which a portion of the external display is disposed, and a second area of the displayable area which corresponds to a remaining area excluding the first area; and
displaying a virtual screen on the second area.

13. The method of claim 12, wherein the identifying of the first area and the second area corresponding to the remaining area excluding the first area among the displayable area comprising:
identifying the movement of the external display based on at least one of sensor data acquired through at least one sensor of the wearable electronic device or the image acquired through the camera; and
identifying the first area and the second area based on the movement of the external display.

14. The method of claim 12, wherein the identifying of the first area and the second area corresponding to the remaining area excluding the first area among the displayable area comprising:
receiving information related to the movement of the external display from an external electronic device which is configured to control the external display; and
identifying the first area and the second area based on the information related to the movement of the external display.

15. The method of claim 14, wherein the external display corresponds to at least one of a window of a vehicle, a sunroof of a vehicle, a window, or a rollable display, and
the external electronic device is at least one of a control device of the vehicle configured to control the window of a vehicle and/or the sunroof of the vehicle, an external electronic device configured to control the window, or an external electronic device configured to control the rollable display.

16. The method of claim 15, wherein the identifying of the displayable area comprising:
identifying that the wearable electronic device is located in the vehicle through a communication module, comprising communication circuitry, of the wearable electronic device;
receiving 3D data of the vehicle from the control device; and
identifying the displayable area by further using the 3D data.

17. The method of claim 12, wherein the displaying of the virtual screen on the second area comprising:
receiving a first content being displayed on the external display from the external electronic device which is configured to control the external display; and
displaying, on the second area, a portion corresponding to the second area among the received first content.

18. The method of claim 12, wherein the displaying of the virtual screen on the second area comprising:
displaying information related to an external environment on the second area, based on movement of the external display which is displaying the first content.

19. The method of claim 18, further comprising displaying virtual information related to the external environment on the second area, based on detection of a user's gaze with respect to the second area through at least one sensor of the wearable electronic device.

20. A non-transitory computer readable recording medium storing at least one program,
wherein the at least one program stores instructions in the medium configured to cause a wearable electronic device to:
identify a displayable area corresponding to an external display included in an image of a space through a camera of the wearable electronic;
identify, based on at least a portion of the external display being excluded from the displayable area due to movement of the external display, a first area of the displayable area, in which a portion of the external display is disposed and a second area of the displayable area which corresponds to a remaining area excluding the first area; and
control a display of the electronic device to display a virtual screen on the second area.
